(19) United States
(12) Patent Application Publication
(10) Pub. No.: US 2025/0343389 A1
(43) Pub. Date: Nov. 6, 2025

(54) VISIBLE CERAMIC LASER, GAIN MEDIUM FOR SAME, AND PROCESS OF MAKING THE GAIN MEDIUM

(71) Applicant: IMRA AMERICA, INC., Ann Arbor, MI (US)

(72) Inventors: Yiyu LI, Carlsbad, CA (US); Hiroyuki YADA, Ann Arbor, MI (US); Yuki ICHIKAWA, Ann Arbor, MI (US)

(73) Assignee: IMRA AMERICA, INC., Ann Arbor, MI (US)

(21) Appl. No.: 18/652,442

(22) Filed: May 1, 2024

(51) Int. Cl. H01S 3/16; H01S 3/0941

(52) U.S. Cl. CPC H01S 3/1685; H01S 3/09415; H01S 3/1613; H01S 3/1698

(57) ABSTRACT

A visible laser or laser amplifier is provided with a ceramic gain medium having a uniaxial anisotropic scattering property such that scattering losses for a visible laser beam along one axis are lower than that along perpendicular axes, and that axis is used as the optical path. The ceramic gain medium includes at least a trivalent praseodymium dopant (Pr³⁺) within a host body based on CaF₂, SrF₂, BaF₂, or a solid solution thereof. Co-dopants can include one or more other trivalent rare earth (RE) elements chosen from Lu³⁺, Y³⁺, Gd³⁺, and La³⁺. The ceramic gain medium, which is made from wet-chemistry precipitated powders, undergoes uniaxial compression, generally under high heat, as an essential step in its manufacture. In use, a pump source using a laser diode of gallium nitride-based semiconductor can be advantageously paired with the gain medium.

### BACKGROUND OF THE INVENTION

Visible light lasers (defined as the wavelength range of 380 to 780 nm) have been the subject of renewed attention due to the emergence of ultraviolet and blue laser diodes. For example, InGaN-based blue laser diodes having a wavelength around 440-450 nm can excite trivalent praseodymium (Pr³⁺) doped gain materials, which because of its energy level scheme can provide several transitions in the visible light regime including blue, green, orange, red, and deep red.

The state of the art and the present invention will be described herein with reference to bibliographic endnotes in numerical sequence, with their number given in brackets [ ] to give the reader ready access to background information. The references referred to in these endnotes, as filed, are hereby incorporated by reference herein.

Various visible laser oscillations in Pr³⁺ doped fluoride single crystals such as Pr³⁺: LiYF₄ crystal [1-4], Pr³⁺: LiLuF₄ crystal [1, 4], Pr³⁺: LiGdF₄ crystal [4], Pr³⁺: LaF₃ crystal [5], Pr³⁺: SrF₂ crystal [6, 7], Pr³⁺, Gd³⁺: SrF₂ crystal [8], Pr³⁺, Gd³⁺: CaF₂ crystal [9], and Pr³⁺: ZBLAN (typical composition: 53% ZrF₄, 20% BaF₂, 4% LaF₃, 3% AlF₃, and 20% NaF) glass have been reported, and red pulse amplification using Pr³⁺: LiYF₄ crystals has also been reported [11, 12]. Green pulse amplification has been recently demonstrated using a Pr³⁺: LiYF₄ crystal as a gain medium material with InGaN based semiconductor lasers as the excitation source [13, 14].

However, there are production issues with single crystal lasers. Growing single crystals for laser applications, particularly growing fluoride crystals which are one of the major host materials for visible lasers, requires special and complex facilities, and a long crystal-growth time (for example, it can take 10 days to grow a LiYF₄ laser crystal [15]), both of which lead to the high fabrication cost. Moreover, there are technical issues still present in the melt-growth process of single crystal production, such as heat fluctuation during melting and the segregation of laser-active dopants at the interface of the solid-liquid phase during crystal growth. Also, striation, facet, core, and optical stress are often present in single crystals fabricated via the melt-growth process, making them optically inhomogeneous [16]. So suppliers capable of providing high-quality laser-grade single crystals are limited. In cases where a single crystal is used for laser pulse amplification, the gain width is limited due to the strong crystalline nature, which potentially limits the available shortest duration of the amplified pulse and the net amplification efficiency. Finally, if a crystal has a low symmetry crystal structure, the crystal anisotropy leads to an anisotropic thermal lens effect which can deteriorate spatial beam quality during pulse amplification, and can also make it challenging to design and align the cavity with high power excitation.

Therefore, in consideration of these issues, it is of importance to explore alternative materials for visible laser gain media. From a materials science point of view, considering the wide band gap and the cubic crystal structure, certain alkaline-earth metal fluorides such as calcium fluoride (CaF₂), strontium fluoride (SrF₂), and barium fluoride (BaF₂) present as preferable host materials that can avoid excited state absorptions and strong anisotropic effect. They possess a cubic fluorite phase, and thus the anisotropic thermal lens effect can be avoided. In addition, these alkaline-earth fluoride single crystals have comparable or higher thermal conductivities (9.7 W/m· K for CaF₂ [17, 18]; 8.3 W/m·K for SrF₂ [17]; 7.0 W/m·K for BaF₂ [19]), compared with LiYF₄ single crystal (5.8 W/m· K|c; 7.2 W/m·K Lc) and ZBLAN glass (0.628 W/m·K) [20], which will be of help in high power laser applications. In U.S. Pat. No. 8,995,488 [21], an amplifier using an ytterbium doped SrF₂ crystal was described. However, doping with ytterbium did not produce visible light amplification but rather infrared light amplification, and the laser material must be cooled to 250 K or lower. In addition, visible lasing in red and orange wavelength ranges have been reported in single crystals of Pr³⁺: SrF₂ (at 639 nm) [6, 7], Pr³⁺, Gd³⁺: SrF₂ (at 605.98 nm) [8], and Pr³⁺, Gd³⁺: CaF₂ (at 642 nm) [9]. However, the problems of high cost and size limitations owing to the use of single crystal remain unresolved.

These problems have led the inventors to investigate the development of visible laser ceramics. Ceramics are promising for low cost, short delivery time, relatively high thermal conductivity, high fracture toughness, and easiness of quality control for the critical features for laser use, such as a high amplification efficiency, a broad gain width, a short pulse duration, and good spatial beam quality. Herein, the inventors define a “ceramic” as a nonmetallic, inorganic polycrystalline solid material that can generally be made by consolidation/densification of ceramic powders at elevated temperatures (e.g., sintering).

Compared with a single crystal fabricated via a conventional growth process, a ceramic can be fabricated in a larger size, with lower-cost equipment, in a shorter processing time, and with better quality control. Thus, if the optical quality required for visible laser material can be realized in ceramic, the ceramic will be more suitable for cost-effective mass production. As represented by neodymium glass lasers, a glass can also be used as a host material to incorporate active dopants for laser media. However, ceramics have superior thermal conductivity in comparison with glasses. The mean free path of phonons (typically less than 10 nm) is one of the factors determining the thermal conductivity of a material. Since a ceramic is formed of polycrystals whose size is generally larger than the mean free path, the thermal conductivity of ceramics is comparable to that in single crystals [22]. In addition, the presence of grains and grain boundaries in a ceramic can be beneficial for inhibiting crack propagation. As a result, the fracture toughness of polycrystalline ceramics is higher than that of single crystals [23-25]. Thus, the combined properties of ceramics, i.e. good thermal conductivity and fracture toughness, are favorable for optical, thermal and mechanical durability, which is essential for reliable laser performance in industrial applications.

In addition, as potential gain materials for laser applications, ceramics have at least two advantages in terms of laser design and engineering; the first being the ease of finely tuning the chemical compositions, and the second being the controllability of the spatial distribution of the active dopant. The former enables the control of absorption/emission properties including tuning of wavelength. The latter enables, for example, designing the light propagation path as well as spatially controlling brightness inside the laser medium through spatial modification of refractive index, including higher order refractive index, as well as spatial distribution of active dopants. Such controllability can be utilized to improve, for example, the quality of the laser beam, and heat dissipation [16].

Through intensive efforts to fabricate transparent ceramics in the infrared region, infrared laser ceramics, as represented by Nd³⁺: Y₃Al₅O₁₂ (Nd³⁺: YAG), have been successfully fabricated [16]. However, visible laser ceramics are more challenging due to the difficulty of achieving high transparency in the visible wavelength range, which is mainly and easily affected by the light scattering (optical scattering) in ceramics. The residual pores and impurities within a ceramic can cause the light to be scattered (by Rayleigh scattering), attributable to the difference in refractive index between the primary ceramic material and the residual pores or impurities. In addition, a ceramic (composed of randomly oriented ceramic grains) possessing an anisotropic crystal structure can also lead to light scattering (by Rayleigh scattering) due to the difference in refractive index between different axes. According to the Rayleigh law, the scattering intensity is inversely proportional to the fourth power of wavelength, making scattering in the visible wavelength range more intense than that in the infrared wavelength range. For example, in comparing a 1042 nm near-infrared wavelength with a 521 nm visible (green) wavelength, the scattering intensity is 16 times higher for 521 nm than 1042 nm. Such severe wavelength dependence of optical scattering in ceramics makes the realization of laser oscillation in the visible wavelength range challenging.

Due to the challenge of making highly transparent ceramics in the visible wavelength range, as of today, there are not many reports of successful visible laser operation using a ceramic as an active material. Basiev et al. [6] achieved lasing (639 nm) in a 0.3% Pr³⁺: SrF₂ ceramic, under InGaN blue laser diode optical pumping at 444 nm, in CW mode. The Pr³⁺: SrF₂ ceramic was fabricated by a so-called “hot pressing/forming method”, where the single crystal of Pr³⁺: SrF₂ was fabricated first, and then the single crystal was deformed via hot pressing/hot forming at high temperature in argon gas to form a polycrystalline Pr³⁺: SrF₂ ceramic. However, due to the use of single crystal as the precursor in this processing route, the fabrication process of the Pr³⁺ doped SrF₂ single crystal precursor and the resulting ceramic is inefficient, time-consuming and expensive, making it less desirable and unrealistic for industrial employment.

Fujita et al. reported orange lasing (616 nm) in Pr³⁺: YAG ceramics at 40 K. The cryogenic temperature is essential for lasing due to the fact that the unfavorable excited state absorption in the oxide has to be suppressed by lowering temperature. Therefore, a practical visible laser ceramic, which can enable laser operation at a room temperature and which can be fabricated by cost-effective and time-saving processes, is still demanded.

Following the success of visible lasing in fluoride ceramics [6], several investigations on alkaline-earth metal fluoride (CaF₂, SrF₂, and BaF₂) ceramics aimed at fabricating transparent ceramics via alternative synthesis methods have been tried for potential visible laser applications [27-34]. Alkaline-earth fluorides (belonging to the cubic crystal structure system; with a large band gap) are potentially suitable for visible laser uses. Through vacuum hot pressing of co-precipitated synthetic nanopowders, G. Yi et al. successfully fabricated Pr³⁺ doped CaF₂ and Pr³⁺, Gd³⁺ co-doped CaF₂/SrF₂ transparent ceramics [27-30]. It was shown that the addition of Gd³⁺ in the Pr³⁺ doped CaF₂/SrF₂ ceramics could lead to apparent enhancements in the Pr³⁺-induced visible photoluminescence emissions. Z. Liu et al. mixed the co-precipitated SrF₂ powder with known PrF₃/LaF₃ powders, and then applied hot pressing of the powders to form transparent Pr³⁺ doped SrF₂ and Pr³⁺, La³⁺ co-doped SrF₂ transparent ceramics [31, 32]. Similarly, it was also found here that the LaF₃ co-doping could result in strengthened Pr³⁺-induced visible photoluminescence emission. In addition, processing studies on the synthesis and densification of Pr³⁺ doped BaF₂ transparent ceramics were performed by X. Liu et al. These Pr³⁺ doped BaF₂ transparent ceramics were similarly processed via hot pressing of chemically synthesized (via co-precipitation) powders [33, 34]. However, although Pr³⁺ doped fluoride transparent ceramics have been demonstrated through the application of hot pressing of lab-processed polycrystalline powders in these recent studies, all of these Pr³⁺ doped fluoride transparent ceramics have failed to succeed in lasing in the visible region (or even in the near-infrared region). The present inventors believe that this could be attributable to either the relatively low optical transmittance or the insufficient photoluminescence emission in the ceramics.

In U.S. Pat. No. 8,000,363 [35], a laser using a Pr³⁺ doped single crystal or polycrystal, including the Pr³⁺ doped CaF₂/SrF₂ polycrystal (ceramic), was described, although no data was shown to demonstrate lasing in the polycrystal (ceramic). Japanese published application JPA2021-134358 has described ceramics using CaF₂, SrF₂, and BaF₂ (as the host materials) doped with Pr³⁺, where Y, La, Gd, and Lu are additionally incorporated as buffer ions. Similarly, another patent application in China, CN106673658A (2017) has specifically described ceramics using Pr³⁺ doped SrF₂, where Y or Gd is co-doped as the buffer ion. However, in these patents, actual lasing using these fluoride ceramic materials is not demonstrated, and the details of parameters such as a transmissivity necessary for achieving lasing are not described.

There is an unmet demand for visible laser ceramics satisfying the following conditions: First, they must be manufacturable by more cost-effective and time-saving fabrication methods (preferably by sintering of chemically synthesized powders), as compared with the hot forming/pressing of single crystal precursors. Secondly, they need to have sufficient absorption at the wavelength of the pumping source. Thirdly, they need to have sufficiently high transparency and emission in the visible region for laser oscillation and/or laser pulse amplification at a visible wavelength.

Hereafter, disclosed are embodiments of a visible ceramic laser and amplifier, the gain medium thereof, and manufacturing methodology of the gain medium.

### SUMMARY OF THE INVENTION

In accordance with embodiments of the invention, a visible laser or laser amplifier (operated at room temperature), comprises a ceramic gain medium having an anisotropic scattering property, wherein the scattering loss for a visible laser beam along one axis is lower than that along a perpendicular axis, and an optical path for laser oscillation or laser amplification in the ceramic is configured to be aligned with the lower scattering loss axis.

In embodiments of the invention, the anisotropic scattering property of the ceramic gain medium is uniaxial, and the scattering loss for a visible laser beam along the axis of the uniaxial direction is lower than that along a perpendicular axis.

In an embodiment of the invention, the ceramic gain medium comprises a praseodymium dopant, and the visible laser or laser amplifier further comprises a gallium nitride-based diode laser for pumping the gain medium, whereby a visible laser is generated, or the seed laser pulse passing through the ceramic gain medium becomes an amplified visible laser pulse.

In an embodiment of the invention, the host material of the ceramic gain material is based on CaF₂, SrF₂, BaF₂, or a solid solution thereof. The composition of the gain material is an alkaline-earth metal fluoride AF₂ (AF₂=CaF₂, SrF₂, BaF₂, or their solid solution) co-doped with trivalent praseodymium (Pr³⁺) and one or more other trivalent rare earth (RE) elements chosen from the group of Lu³⁺, Y³⁺, Gd³⁺, and La³⁺, preferably with the composition being xat. % Pr³⁺, yat. % RE³⁺ co-doped AF₂ (abbreviated as x % Pr³⁺,y % RE³⁺: AF₂), wherein x and y fall within the ranges of 0.2<x<1 and 2<y<10, respectively.

In embodiments according to the invention, the wavelength of laser oscillation or laser amplification can be in the range between 479 nm to 725 nm.

### DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 is a schematic diagram of an embodiment of a visible ceramic laser.

FIG. 2A is a schematic diagram of another embodiment of a visible laser amplifier using ceramics.

FIG. 2B is a schematic diagram of a further embodiment of a visible laser amplifier using ceramics.

FIG. 3 is an energy level diagram for trivalent praseodymium (Pr³⁺) with excitation and emission energies.

FIG. 4 shows the orientation of the ceramic and laser line inside the laser or laser amplifier.

FIG. 5 is a schematic diagram of a Brewster angle arrangement of the laser ceramic in the laser or laser amplifier.

FIG. 6 is a diagram of the fluorite unit cell of the alkaline-earth metal fluoride AF₂ (AF₂=CaF₂, SrF₂, or BaF₂).

FIG. 7A is a schematic process flowchart of shaping a cylindrically-fabricated ceramic into a cuboid-shaped ceramic, also showing the corresponding three (a, b, and c) axes of the ceramic.

FIG. 7B is a schematic diagram illustrating the relation between the axis of the uniaxial processing pressure and the anisotropic axes of a fabricated ceramic with indications of the corresponding (a, b, and c) axes for exemplified cutting.

FIG. 8 shows the XRD pattern of a visible laser ceramic (0.5% Pr³⁺,5% Y³⁺: SrF₂) along with a standard XRD pattern of SrF₂.

FIG. 9 is an SEM image of the surface of a visible laser ceramic (0.5% Pr³⁺,5% Y³⁺: SrF₂).

FIGS. 10A, 10B and 10C are photos of a highly transparent, originally cylindrically-fabricated ceramic (0.5% Pr³⁺,5% Y³⁺: SrF₂; thickness along the α axis: 3.99 mm; polished with 1 μm diamond pads), respectively distanced by 0 mm, 11 mm and 210 mm along the α axis from the sample to the worded paper underneath.

FIG. 11A is a photo of a finely-polished visible laser ceramic (0.5% Pr³⁺,5% Y³⁺: SrF₂) shaped according to the process flowchart in FIG. 7A.

FIG. 11B is a photo of a finely-polished visible laser ceramic (0.5% Pr³⁺,5% Y³⁺: SrF₂) with indicators of the a, b, and c axes (thickness along the α axis: 2.99 mm; thickness along the b axis: 3.46 mm; thickness along the c axis: 5.23 mm).

FIG. 12 shows in-line transmittance spectra of a visible laser ceramic (0.5% Pr³⁺,5% Y³⁺: SrF₂) along a, b, and c axes (with SrF₂'s theoretical transmittance spectrum shown for comparison).

FIG. 13A shows absorption coefficient spectra of a visible laser ceramic (0.5% Pr³⁺,5% Y³⁺: SrF₂) along a, b, and c axes.

FIG. 13B shows absorption coefficients at 520 nm and 800 nm of a visible laser ceramic (0.5% Pr³⁺,5% Y³⁺: SrF₂).

FIG. 14A is an image of a green laser spot whose right half has passed through a visible laser ceramic (0.5% Pr³⁺,5% Y³⁺: SrF₂). The α axis is parallel to the laser direction.

FIG. 14B is an image of the green laser spot whose right half has passed through a visible laser ceramic (0.5% Pr³⁺,5% Y³⁺: SrF₂). The b axis is parallel to the laser direction.

FIG. 14C is an image of the green laser spot whose right half has passed through a visible laser ceramic (0.5% Pr³⁺,5% Y³⁺: SrF₂). The c axis is parallel to the laser direction.

FIG. 15A is an image of a laser spot on a screen after going through a visible laser ceramic (0.5% Pr³⁺,5% Y³⁺: SrF₂), whose α axis is parallel to the laser direction.

FIG. 15B is an image of the laser spot on the screen after going through a visible laser ceramic (0.5% Pr³⁺,5% Y³⁺: SrF₂), whose b axis is parallel to the laser direction.

FIG. 15C is an image of the laser spot on the screen after going through a visible laser ceramic (0.5% Pr³⁺,5% Y³⁺: SrF₂), whose c axis is parallel to the laser direction.

FIG. 16A shows Pr³⁺-activated absorption coefficients at 444 nm of a visible laser ceramic (0.5% Pr³⁺,5% Y³⁺: SrF₂).

FIG. 16B shows Pr³⁺-activated absorption coefficients at 444 nm along the α axis of other Pr³⁺, Y³⁺: SrF₂ active ceramics (i.e., Pr³⁺, Y³⁺ co-doped SrF₂ with various concentrations of Pr³⁺ and Y³⁺).

FIG. 16C shows absorption coefficient (along the α axis) spectra of other 0.5% Pr³⁺,5% RE³⁺: SrF₂ active ceramics (0.5% Pr³⁺,5% Gd³⁺: SrF₂, 0.5% Pr³⁺,5% La³⁺: SrF₂, and 0.5% Pr³⁺,5% Lu³⁺: SrF₂).

FIG. 16D shows absorption coefficients along the α axis at 520 nm and 800 nm of other 0.5% Pr³⁺,5% RE³⁺: SrF₂ active ceramics (0.5% Pr³⁺,5% Gd³⁺: SrF₂, 0.5% Pr³⁺,5% La³⁺: SrF₂, and 0.5% Pr³⁺,5% Lu³⁺: SrF₂).

FIG. 16E shows Pr³⁺-activated absorption coefficients along the α axis at 444 nm of other 0.5% Pr³⁺,5% RE³⁺: SrF₂ active (0.5% Pr³⁺,5% Gd³⁺: SrF₂, 0.5% Pr³⁺,5% La³⁺: SrF₂, and 0.5% Pr³⁺,5% Lu³⁺: SrF₂).

FIG. 17 is an emission cross section spectrum of a visible laser ceramic (0.5% Pr³⁺,5% Y³⁺: SrF₂) under excitation at 444 nm, estimated by the Füchtbauer-Ladenburg method.

FIG. 18 shows emission cross section spectra of a known 0.5% Pr³⁺: LiYF₄ crystal and a known 1% Pr³⁺: ZBLAN glass under excitation at 444 nm.

FIG. 19 shows emission cross section spectra of other 0.5% Pr³⁺,5% RE³⁺: SrF₂ active ceramic samples (0.5% Pr³⁺,5% Gd³⁺: SrF₂, 0.5% Pr³⁺,5% La³⁺: SrF₂, and 0.5% Pr³⁺,5% Lu³⁺: SrF₂) under excitation at 444 nm.

FIG. 20A shows emission cross section spectra in a green region (510-535 nm) of the 0.5% Pr³⁺,5% RE³⁺: SrF₂ active ceramic samples (0.5% Pr³⁺,5% Y³⁺: SrF₂, 0.5% Pr³⁺,5% Gd³⁺: SrF₂, 0.5% Pr³⁺,5% La³⁺: SrF₂, and 0.5% Pr³⁺,5% Lu³⁺: SrF₂), a known 0.5% Pr³⁺: LiYF₄ laser crystal, and a known 1% Pr³⁺: ZBLAN laser glass, in comparison with a spectrum of the second-harmonic generation (SHG) from a ytterbium (Yb) doped silica fiber-based ultrafast pulse laser.

FIG. 20B shows cross section intensities of visible emission peaks in the 0.5% Pr³⁺,5% RE³⁺: SrF₂ active ceramic samples (0.5% Pr³⁺,5% Y³⁺: SrF₂, 0.5% Pr³⁺,5% Gd³⁺: SrF₂, 0.5% Pr³⁺,5% La³⁺: SrF₂, and 0.5% Pr³⁺,5% Lu³⁺: SrF₂), the known 0.5% Pr³⁺: LiYF₄ laser crystal, and the known 1% Pr³⁺: ZBLAN laser glass.

FIG. 20C shows the full widths at half maximum of visible emission peaks in the 0.5% Pr³⁺,5% RE³⁺: SrF₂ active ceramic samples (0.5% Pr³⁺,5% Y³⁺: SrF₂, 0.5% Pr³⁺,5% Gd³⁺: SrF₂, 0.5% Pr³⁺,5% La³⁺: SrF₂, and 0.5% Pr³⁺,5% Lu³⁺: SrF₂), the known 0.5% Pr³⁺: LiYF₄ laser crystal, and the known 1% Pr³⁺: ZBLAN laser glass.

FIG. 21 shows photoluminescence decay curves of the 0.5% Pr³⁺,5% RE³⁺: SrF₂ active ceramic samples (0.5% Pr³⁺,5% Y³⁺: SrF₂, 0.5% Pr³⁺,5% Gd³⁺: SrF₂, 0.5% Pr³⁺,5% La³⁺: SrF₂, and 0.5% Pr³⁺,5% Lu³⁺: SrF₂), the known 0.5% Pr³⁺: LiYF₄ laser crystal, and the known 1% Pr³⁺: ZBLAN laser glass for the green emission at 522 nm under the excitation of a blue laser diode with an excitation wavelength of 444 nm.

FIG. 22 is a schematic diagram of a visible ceramic laser.

FIG. 23 is a schematic diagram of Brewster angle arrangement of the laser ceramic in the laser.

FIG. 24A are parameters for a 0.5% Pr³⁺,5% Y³⁺: SrF₂ visible laser ceramic.

FIG. 24B is a photograph of a 0.5% Pr³⁺,5% Y³⁺: SrF₂ ceramic.

FIG. 25A is the spectrum of the pump light.

FIG. 25B is the absorption spectrum of a 0.5% Pr³⁺,5% Y³⁺: SrF₂ ceramic.

FIG. 26 is a photo of the laser oscillation in a visible laser ceramic.

FIG. 27A is a photograph of the laser spot on the paper.

FIG. 27B is a beam profile taken by CCD camera.

FIG. 27C shows the spectrum of the laser.

FIG. 28A indicates the slope efficiency of the laser calculated by irradiated pump peak power and the laser peak power.

FIG. 28B indicates the slope efficiency of the laser calculated by absorbed pump peak power and the laser peak power.

### DETAILED DESCRIPTION OF THE EMBODIMENTS

Outline of a ceramic visible laser configuration

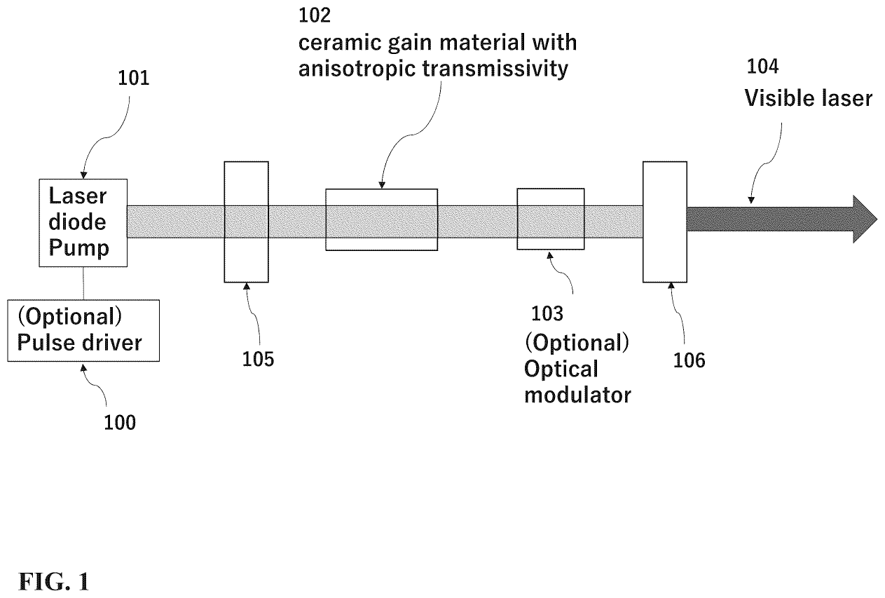

FIG. 1 is a schematic drawing of a visible-light ceramic oscillator according to the disclosure. A pump light is delivered from a laser diode pump 101 to an active ceramic gain material 102, which has anisotropic optical loss axes. Among the anisotropic axes, an axis with a lower scattering loss is aligned parallel to the optical path for laser oscillation. A laser output from laser diode 101 may be focused on an active ceramic gain material 102, whose low-loss axis has been predetermined, placed in a laser cavity comprising two mirrors (105, 106) such that the low-loss axis is set parallel to the expected path of laser oscillation. A partial reflection mirror can be used for 106 as an output coupler. In this configuration, visible laser 104 output can be in either CW mode or pulse mode. Laser diode pump 101 can be operated either in a continuous wave (CW) mode or pulse mode. In the case of pulse mode operation, laser diode pump 101 may be controlled by a pulse driver 100. Optionally, optical modulator 103 can be incorporated in the system to further control the pulse operation.

In the above embodiment, the optical modulator 103 can be an electro- or acousto-optic modulator, a mechanical modulator using a prism or a mirror, or a saturable absorber. Also, the pulse operation may be based on Q-switching or mode-locking.

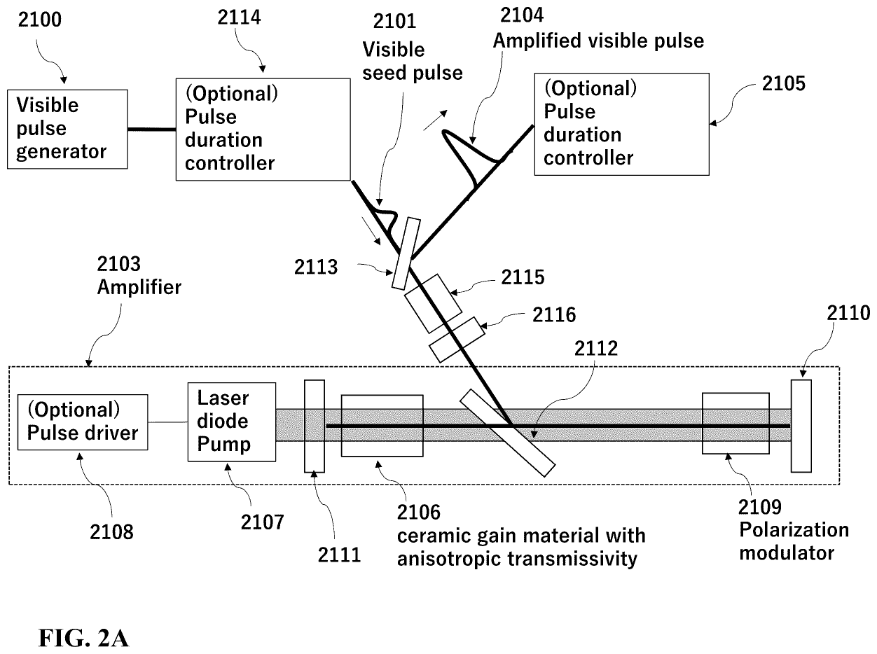

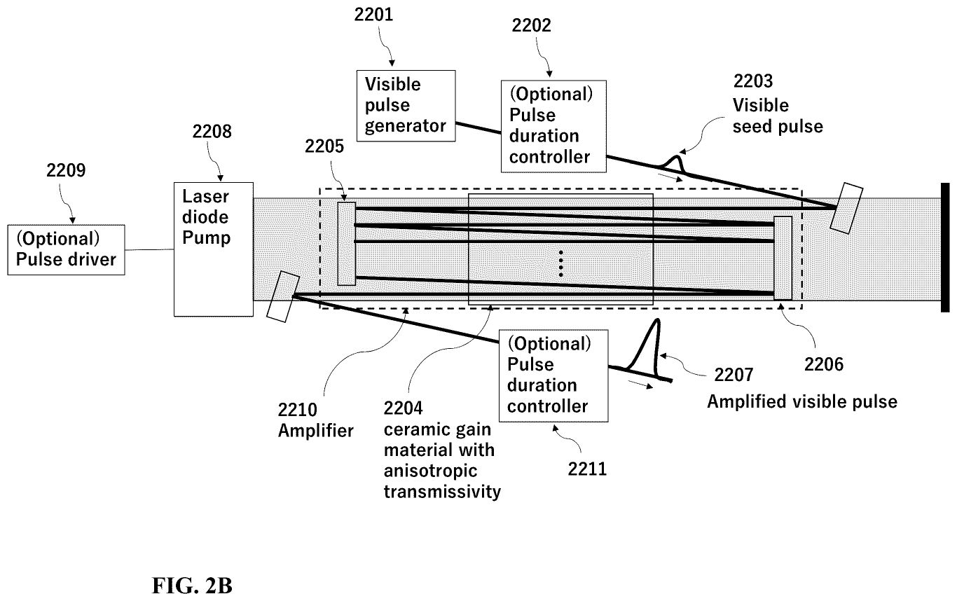

A schematic drawing of a visible-light ceramic amplifier is shown in FIG. 2A as an embodiment for laser amplification. A visible seed pulse 2101 is provided by a visible pulse generator 2100. By having the seed pulse passing through amplifier 2103, direct amplification of the visible laser pulse takes place and visible amplified pulse 2104 is obtained. The amplifier 2103 comprises a ceramic gain material with an anisotropic transmissivity 2106, a laser diode pump 2107 which can be optionally operated by a pulse driver 2108, a polarization modulator 2109, cavity mirrors 2110, 2111, and a thin film polarizer 2112. Laser light from the laser diode 2107 may be focused on active ceramic gain material 2106, whose low-loss axis has been predetermined, placed in the laser cavity between the two mirrors 2110, 2111 such that the low-loss axis is set along the expected path of the laser seed pulse. By operating a polarization modulator 2109, the number of round trip passes within the cavity between mirrors 2110, 2111 can be controlled by controlling its polarization. During the confinement of the seed pulse inside the cavity, the intensity of the visible pulse increases as it passes through the ceramic gain material with anisotropic transmissivity 2106. In order to increase the efficiency of amplification and to avoid parasitic lasing or amplified spontaneous emission, the optical path is preferred to be parallel to the low-loss axis of the ceramic gain material so that scattering losses along other axes are enhanced to suppress the unfavorable phenomena. After the round-trip amplification pass(es) (1 round trip or multiple round trips), the amplified visible pulse is extracted from the cavity via a polarizing beam splitter 2112, which may be a thin film polarizer or a polarizing beam splitter, by changing the polarization of the pulse through a polarization modulator 2109. As one example, the polarization modulator 2109 can be a quarter waveplate and a Pockels cell.

The extracted amplified pulse is separated from the optical path used for the injection of the seed pulse 2101 at a polarizing beam splitter 2113, which may be a thin film polarizer or a polarizing beam splitter, as the polarization changes by 90 degrees after a Faraday rotator 2115 and a half waveplate 2116. For example, if a Pr³⁺ doped ceramic gain material is used in amplifier 2103 with a blue pump laser 2107 and a green pulse laser pulse as visible pulse generator 2100, an amplified pulse in the green region can be obtained. This corresponds to the change of gain materials from LiYF₄ crystal to a Pr³⁺ doped ceramic gain material in a green pulse amplification demonstrated by Yada et al. using a LiYF₄ crystal as the gain material [13, 14].

In the above embodiment, the amplifier can be, but is not limited to be, a regenerative amplifier. It can also be a two-pass amplifier. In the case of a two-pass amplifier, the polarization modulator 2109 can be a quarter waveplate or combination of a quarter waveplate and a half waveplate. Also, the amplifier can be, but is not limited to being a pulse amplifier. It can also be a CW amplifier. In the case of a CW amplifier, the seed pulse generator 2100 and the seed pulse 2101 may be replaced with a CW visible light generation source and CW visible light, respectively.

A schematic diagram shown in FIG. 2B depicts another embodiment of a laser amplifier for visible pulse amplification. The visible seed pulse 2203 from a visible pulse generator 2201 is injected into a ceramic gain material with anisotropic transmissivity 2204. The visible seed pulse 2203 experiences multiple-pass amplification as it traverses multiple paths through the ceramic gain material 2204 under excitation by a laser diode pump 2208. In this multiple (zigzag) path configuration, all paths cannot be perfectly parallel to the low-loss axis. However, as long as each path is close to parallel to the low-loss axis, the scattering loss in the ceramic 2204 can be expected to be minimized. More specifically, the incident pulse experiences 1^{st} amplification in the ceramic 2204, excited by a laser diode pump 2208, which may be optionally operated by a pulse driver 2209. This first path may be parallel to the low-loss axis. The angle of the mirror 2205 to the incident pulse may be slightly different from 90 degrees. For the 2^{nd} amplification process, the reflected pulse enters the ceramic 2204 from the other end, propagating in a slightly different path from that used during the 1^{st} amplification process. This is beneficial in that it yields a higher efficiency compared with the case where the same path inside the gain ceramic is continuously being used as in FIG. 2A. The 2^{nd} amplified pulse is further reflected by the mirror 2206, whose angle to the pulse is again slightly different from 90 degrees. In this manner of zigzag path propagation, more efficient amplification can be expected. After an arbitrary number of round trips, the amplified visible pulse 2207 is extracted.

The laser light from a laser diode pump 2208 illuminates the active ceramic gain material 2204 such that the illuminated area totally covers all of the pulse traces in the ceramic gain material 2204. The low-loss axis of the ceramic 2204 is predetermined and the ceramic is placed between the two mirrors 2205, 2206 such that the low-loss axis is set almost parallel to the expected paths of the seed laser pulse. In this arrangement, the duration of the pulse can be as short as 0.1 ps. It can also be CW or a modulated optical wave.

In the embodiments of FIG. 1, FIG. 2A, and FIG. 2B, only one ceramic is shown, but the number of the ceramic gain elements with anisotropic transmissivity (102, 2106, 2204) is not limited to one. More than one ceramic gain element (102, 2106, 2204) can be used with a modification of the laser or laser amplifier configuration.

The pulse duration of the visible seed pulse delivered to amplifier 2103, 2210 can be modified by a pulse duration controller 2114, 2202. Depending on pulse energy and duration, the visible seed pulse 2101, 2203 can damage the gain material 2106, 2204 of amplifier 2103, 2210 during pulse amplification. To lower the temporal peak intensity of the laser field in the pulse, for example, a chirped pulse amplification method can be applied. In this case, the pulse duration controller 2114, 2202 serves as a pulse stretcher. The pulse stretcher can be an optical fiber, a prism pair, a diffraction grating, a grism pair (a combination of a prism and a diffractive grating), a fiber Bragg grating, a chirped dielectric mirror, or a bulk Bragg grating.

After the amplifier, optionally, another pulse duration controller 2105, 2211 can be added to achieve an ideal pulse duration for an intended application. For example, the pulse duration controller 2105, 2211 can be a pulse compressor comprising a diffraction grating pair, a prism pair, a grism pair, a chirped dielectric mirror, a bulk Bragg grating, a fiber Bragg grating, or a hollow-core fiber.

The pump laser diode 101, 2107, 2208 in FIG. 1, FIG. 2A or FIG. 2B can be a GaN-based laser, such as blue Indium gallium nitride (InGaN) laser diode (LD), including but not limited to a chip-type, bar-type, a fiber-delivery-type or a combination of the same. To achieve a higher pump power, multiple LD chips can be arrayed, multiple LD bars can be stacked, or multiple fiber-delivery outputs can be bundled or arrayed.

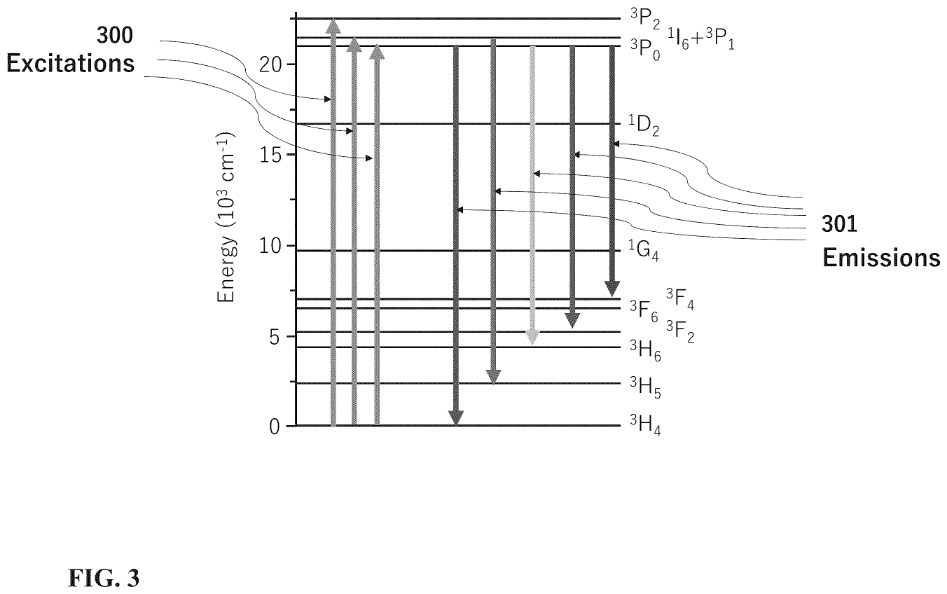

Regarding the wavelength of the pump laser diode 101, 2107, 2208, since the absorption of Pr³⁺ is dependent on the host material of praseodymium (Pr) doped gain material (102, 2106, 2204), it is preferable that the peak wavelength be tunable for efficiently pumping Pr doped gain material 102, 2106, 2204. Thus. a wavelength range preferably between 435 nm and 490 nm is desired. In addition, it is also possible to employ two or three different wavelengths aimed at two or three excitations 300 (e.g., ³H₄→³P₂, ³H₄→¹I₆+³P₁, ³H₄→³P₀) in FIG. 3 simultaneously.

In the embodiment described in FIG. 2A and FIG. 2B, the color of the visible seed pulse 2101, 2203 can be red, orange, green, or blue. In the case of green light, the visible pulse generator 2100, 2201 can be the second harmonic generation (SHG) of an ytterbium (Yb)-doped silica or phosphate glass fiber pulse laser, or the SHG of a pulse laser comprising a Yb-doped gain crystal such as Yb³⁺: YVO₄, Yb³⁺: KGd(WO₄)₂, Yb³⁺: KY(WO₄)₂, Yb³⁺: KLu(WO₄)₂, Yb³⁺: NaGd(WO₄)₂, Yb³⁺: Sr₃Y(BO₃)₃, Yb³⁺: GdCa₄O(BO₃)₃Yb³⁺: Sr₅(PO₄)₃F, Yb³⁺: SrY₄(SiO₄)₃O, Yb³⁺: Y₂SiO₅, Yb³⁺: CaAlGdO₄, Yb³⁺: CaF₂ or Yb³⁺: SrF₂. Further, the visible pulse generator 2100, 2201 can be a third harmonic generator of an erbium (Er) doped fiber laser, optical micro-comb pulse laser, a mode-locked green pulse laser comprising a Pr-doped gain material, an optical parametric amplifier comprising titanium sapphire crystal, a gain switched diode laser or other pulse laser sources. A supercontinuum pulse laser source can be considered as well, as long as a part of the spectrum widened by a nonlinear process, including but not limited to by the use of a nonlinear fiber, has an overlap with the gain band of Pr³⁺. In the case of red, orange, or blue visible seed pulses 2101, 2203, visible pulse generator (2100, 2201) can be a mode-locked pulse laser comprising a Pr³⁺-doped gain material, an optical parametric amplifier comprising titanium sapphire crystal, a gain switched diode laser or other pulse laser sources, part of whose spectrum matches up with the gain band. The same as with the green seed pulse, a supercontinuum pulse laser source can be considered.

### Gain Medium for a Visible Laser

Trivalent RE ions such as Pr³⁺, Tb³⁺ and Dy³⁺ are one of the groups that can be used as active dopants of the gain medium for a visible solid-state laser or a fiber laser. Some trivalent transition metal ions such as Cr³⁺ are also capable of lasing in the visible region.

In an embodiment, Pr³⁺ is used as an active dopant for a visible laser medium. FIG. 3 is an energy level diagram for Pr³⁺, showing excitations and emissions. For a visible ceramic laser or laser pulse amplifier, a Pr³⁺ doped gain material can be employed utilizing the energy levels for a 3- or 4-level laser system. Pr³⁺ can be excited from the ground state ³H₄ level to ³Pⱼ(j=2, 1, 0) levels by blue light 300. In the case of a Pr³⁺ doped yttrium lithium fluoride (Pr³⁺: LiYF₄) crystal with blue laser excitation having polarization parallel to the crystal axis (x), the absorption bands are located around 444 nm, 469 nm, and 479 nm [1], respectively. Depending on the crystal field and the crystal axes of the host material, the energy levels of ³P₂, ³P₁ or ³P₀ can differ slightly. For example, as observed in Pr³⁺ doped lanthanum trifluoride (Pr³⁺: LaF₃) crystal, they are at about 442.0 nm (o polarization), 461.6 nm (x polarization), and 479.0 nm (x polarization) [5]. Preferably, the photon energy of pump laser diode 300 is tunable to match up with the energy difference between the ³H₄ level and ³P₂, ³P₁ or potentially ³P₀ level so that efficient pump absorption occurs to induce a population inversion. For the case of Pr³⁺: LiYF₄ crystal, continuous wave (CW) green lasing is observed in the range from 522 nm to 523 nm (523 nm [1], 522.6 nm [2], 523 nm [3], and ˜522 nm [4]), which can be attributed to the transition from ³P₁ to ³H₅ [1, 4]. Similarly to the absorption bands, the wavelength of the green oscillation can vary depending on the crystal field and the crystal axes of the host material, which can be seen in Pr³⁺: LaF₃ crystal at 537.1 nm [5]. In addition to the green lasing, other visible lasings (blue, orange, red, and deep red) in Pr³⁺ doped fluoride crystals and glasses can be realized. Reported visible laser oscillation wavelengths include, but are not limited to 523 nm, 607 nm, 640 nm, and 720 nm in Pr³⁺: LiYF₄ and Pr³⁺: LiLuF₄ crystals [1], 522.6 nm, 545.9 nm, 607.2 nm, and 639.5 nm in Pr³⁺: LiYF₄ and Pr³⁺: LiLuF₄ [2], 523 nm, 604.1 nm, 606.9 nm, 639.4 nm, 697.8 nm, and 720.9 nm In Pr³⁺: LiYF₄ [3], 522 nm, 607 nm, 640 nm, and ˜720 nm in LiLuY₄, LiYF₄, LiGdF₄ [4], and 537.1 nm, 612.0 nm, 635.4 nm, and 719.8 nm in Pr³⁺: LaF₃ crystal [5], and 479-497 nm, 515-548 nm, 597-737 nm in Pr³⁺: ZBLAN glass [10].

a Laser Configuration Using a Ceramic with an Anisotropic Scattering Property

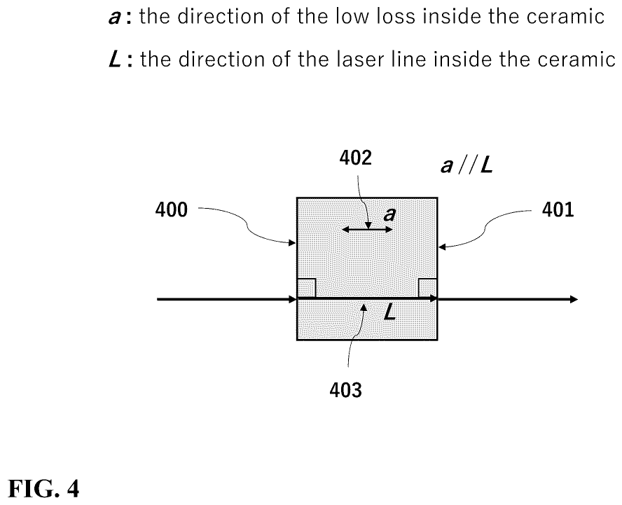

FIG. 4 illustrates an exemplified shape of a ceramic gain material and its arrangement in the visible lasers or amplifiers shown in FIG. 1, FIG. 2A or FIG. 2B. Since the laser ceramic disclosed herein has an orientation-dependent scattering coefficient, i.e. an anisotropic scattering property, the direction of the laser inside the ceramic L 403 is preferred to be aligned parallel to the axis a 402, along which the scattering coefficient inside the ceramic is lowest. In an embodiment, the front surface 400 and the end surface 401 of the ceramic can be cut such that the two surfaces are parallel to each other and are perpendicular to the low optical loss axis a 402.

The benefits of aligning the anisotropic scattering axis include, but are not limited to an increase in laser efficiency by enhancing the transmissivity of the ceramic inside the laser cavity, and the suppression of parasitic lasing in any other direction due to the enhanced scattering loss in the radial directions perpendicular to the low scattering or low-loss axis a 402.

For pumping efficiency, the uniaxial scattering property can also be beneficial. For example, in the case of a collinear pumping configuration where laser oscillation or amplification occurs in the same direction as the pump light, the diffusion of pump light in the radial directions is suppressed due to the higher scattering coefficient in the radial directions. Particularly, the pump laser wavelength is shorter than the lasing wavelength, and therefore the Rayleigh scattering effect is more prominent at the shorter pump laser wavelength, which leads to better confinement of the pump beam in the ceramic.

To further reduce the optical loss in the direction of laser oscillation or amplification, the surfaces 400 and 401 of the ceramic can be coated with an anti-reflection coating for a specific visible laser wavelength and/or pumping wavelength, so as to decrease the reflection losses at the two surfaces 400 and 401.

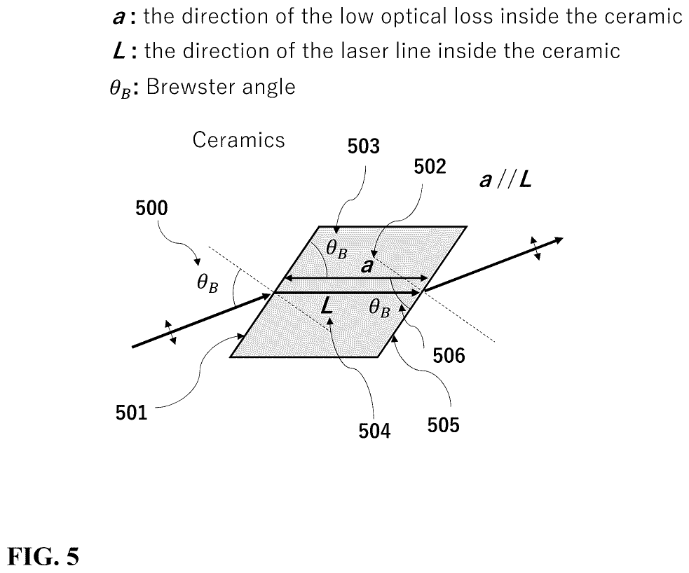

FIG. 5 illustrates another embodiment of the shape and arrangement of the visible laser ceramic (102, 2106, 2204) described in FIG. 1, FIG. 2A or FIG. 2B. As in the prior embodiment, a predetermined low scattering or low-loss axis a 502 of the ceramic body is aligned parallel to the direction of the laser path within the ceramic L 504. The front surface 501 and the end surface 502 of the ceramic are cut and polished in parallel to each other. The axis a 502 and the front surface (or the end surface) are arranged at the Brewster angle θ_{B} 503 in the plane of the incident and diffracted laser beam. The Brewster angle θ_{B} for 503 or 506 is calculated based on the refractive index n of the ceramic at the wavelength of laser operation. In this embodiment, the reflection loss of the laser or laser pulse in p polarization is minimized and the transmissivity of the ceramic inside the laser is maximized. Other benefits such as the suppression of unfavorable parasitic lasing can also be obtained in this configuration.

In the embodiments of FIG. 4 and FIG. 5, the wavelength of the ceramic laser is not limited to the visible region. When the uniaxial property is present in the infrared or near-infrared, ceramics based on alkaline-earth metal fluorides, such as CaF₂, SrF₂, BaF₂, or a solid solution of same, the above—mentioned benefits can likewise be obtained using the laser configuration shown in FIG. 4 and FIG. 5. We define light having a wavelength in the range from 780 nm to 10000 nm as infrared light. We define light having a wavelength in the range from 780 nm to 2500 nm as near-infrared light. The one or more than one active dopant in the infrared or near-infrared laser ceramics based on alkaline-earth metal fluorides can be selected from the group of Pr³⁺, Nd³⁺, Eu³⁺, Tb³⁺, Dy³⁺, Ho³⁺, Er³⁺, Tm³⁺, and Yb³⁺. One or more buffer ions can be selected from the group of Lu³⁺, Y³⁺, Gd³⁺, and La³⁺, if necessary.

### the Composition of the Visible Laser Ceramics

To make a highly transparent ceramic, which is a prerequisite for a laser material, the cubic crystal structure is preferred because of its unique isotropic characteristics among all the crystal structures. The isotropic refractive index in the cubic crystal structure makes it possible for a ceramic with randomly-oriented ceramic grains to avoid the light scattering resulting from the difference in refractive index between different axes. Alkaline-earth metal fluorides, particularly CaF₂, SrF₂, BaF₂ and their solid solutions, are considered good candidates for the host material not only because of their cubic crystal structure, but also their high thermal conductivity compared with other fluorides [17-19]. In addition, the wide band gaps of these alkaline-earth metal fluorides result in short UV-Visible transmittance cut-off wavelengths, making these materials suitable for visible laser host materials. In addition, the excited state absorption observed

in oxides can be avoided in alkaline-earth metal fluorides. However, due to the charge mismatch between the divalent alkaline-earth metal ions and the trivalent active dopant ions, effective incorporation of trivalent dopants into a divalent alkaline-earth metal fluoride host such as CaF₂, SrF₂, BaF₂ or their solid solution can be difficult because of insufficient charge compensation (mainly achieved by isolated dopant ions and interstitial fluoride ions).

More importantly, as the doping concentration increases, the trivalent RE dopants tend to aggregate easily and form clusters, which will decrease the quantum efficiency and emission intensity due to the interatomic interaction in the clusters [38, 39]. Ineffective incorporation and clustering of the trivalent RE dopants can also lead to a relatively low Pr³⁺-activated absorption in SrF₂ polycrystalline ceramics doped only with Pr³⁺ [6], which would be deleterious or inconvenient in industrial laser applications. Kitajima et al. fabricated Yb³⁺. doped CaF₂—LaF₃ ceramics using LaF₃ as the counterpart of the solid solution to reduce the formation of divalent Yb²⁺-ions in the ceramic, which is detrimental to laser efficiency. G. Yi et al. [28-30] and Z. Liu et al. co-doped another non-radiative trivalent RE element such as Gd³⁺ or La³⁺, with the active Pr³⁺ dopant, into CaF₂ and SrF₂ ceramics. They reported that the co-dopants could modify the emission spectrum of Pr³⁺ as well as enhance the emission intensity.

CaF₂, SrF₂ and BaF₂ have the same face-centered cubic crystal structure, called “fluorite structure”, and they have similar characteristics in their physical and chemical properties 40, 41]. And it is known that they can easily form solid solutions [41, 42]. Therefore, although this disclosure mainly describes SrF₂ and related materials in descriptions of embodiments, the scope of the invention is not limited to SrF₂ and related materials but also includes CaF₂ and BaF₂ and their solid solutions such as CaₓSr₁₋ₓF₂, SrₓBa₁₋ₓF₂, CaₓBa₁₋ₓF₂ (0<x<1), and CaₓSr_{1-x-y}Ba_{y}F₂ (0<x, y, x+y<1).

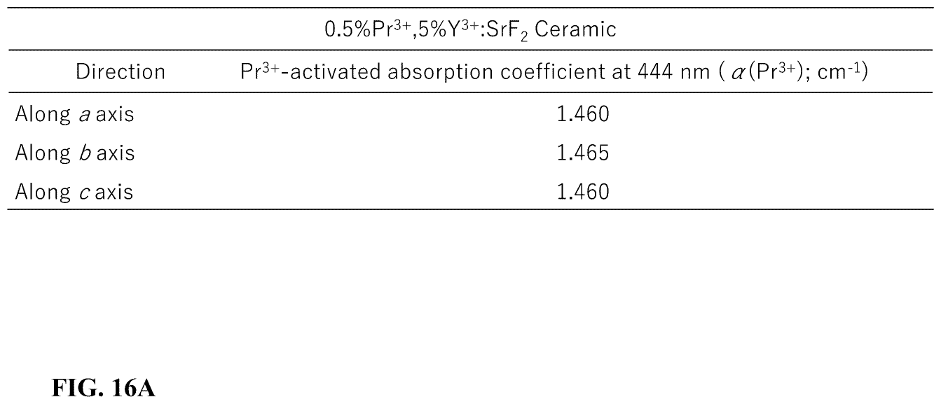

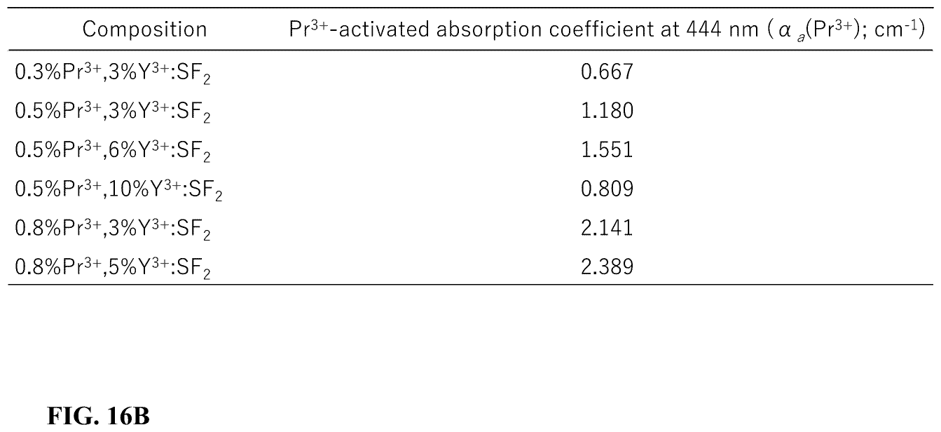

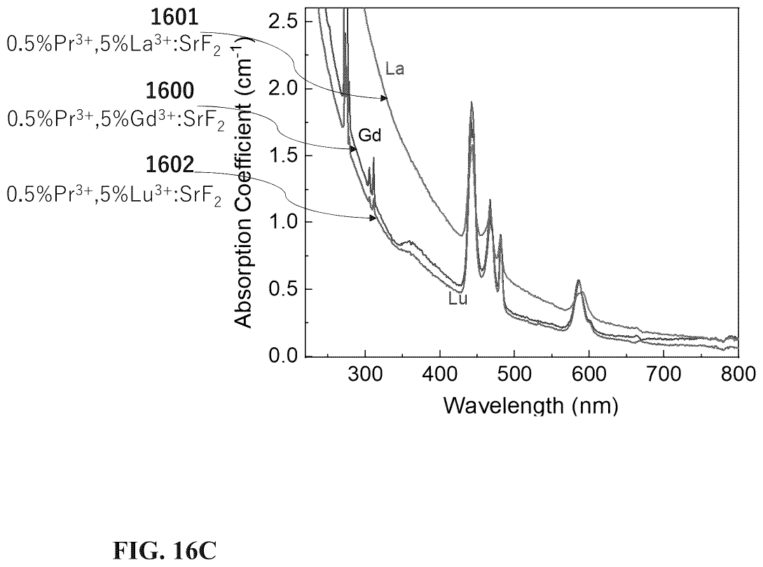

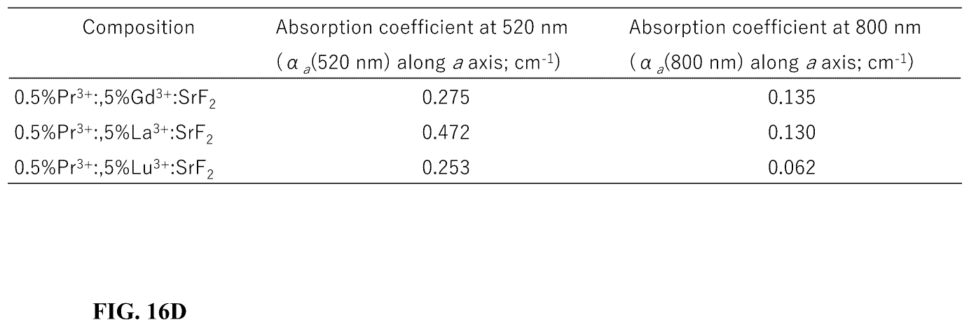

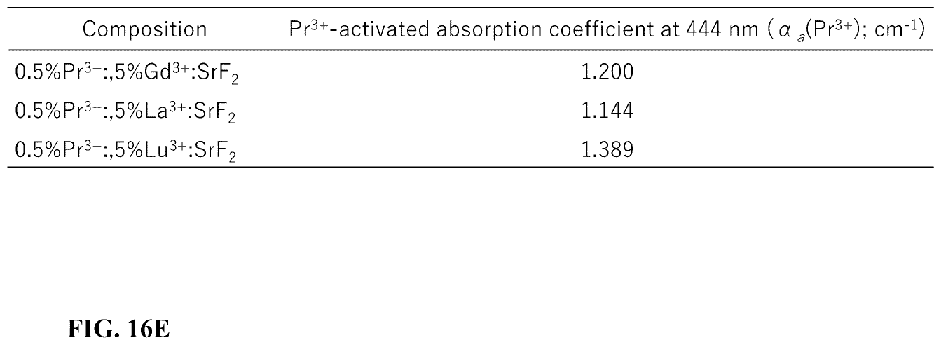

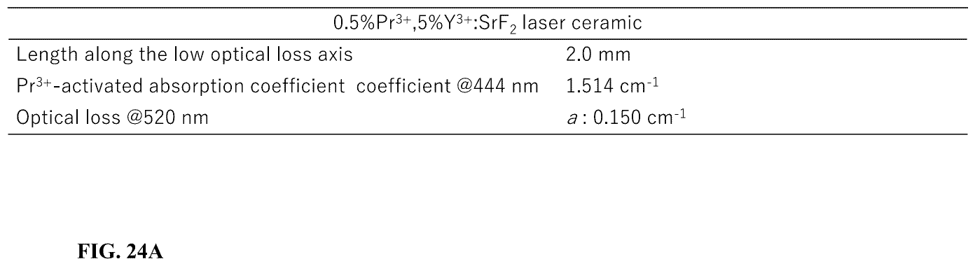

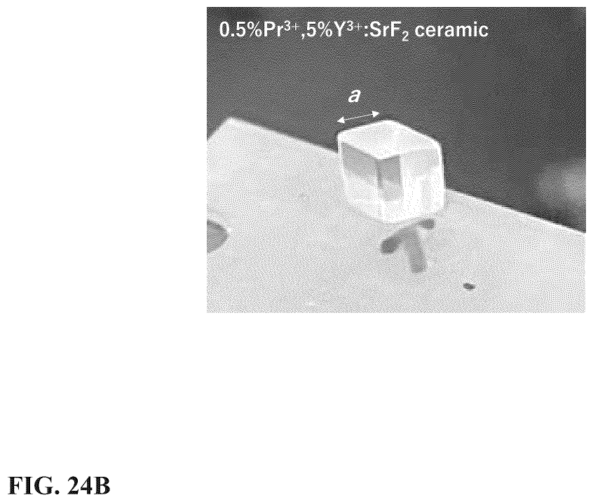

In an embodiment, visible laser ceramics of the invention are primarily composed of alkaline-earth metal fluorides (such as CaF₂, SrF₂, BaF₂, or their solid solution) co-doped with Pr³⁺ and other trivalent RE elements (such as Lu³⁺, Y³⁺, Gd³⁺, La³⁺, or their combination). The RE elements co-doped with Pr³⁺ work as buffer ions in the ceramic system, to effectively activate Pr³⁺ for efficient absorption of blue pumping light at 444 nm, as well as for photoluminescence enhancement. For example, in the case of SrF₂ ceramics wherein x at. % of Pr³⁺ and y at. % of RE³⁺ are co-doped (abbreviated as x % Pr³⁺,y % RE³⁺: SrF₂), a preferred range for x is from 0.2 to 1 while a preferred range for y is from 2 to 10. Regarding the range of x, as shown in FIG. 16B, the doping concentration of Pr³⁺ was successful in the range of 0.3% to 0.8%. More doping may be possible, but when the doping concentration is above 1%, concentration quenching can occur in the case of Pr³⁺. This can lead to a decrease in absorption and emission intensity. Therefore, a Pr³⁺ doping concentration of 1% can be the upper limit for visible laser ceramics. Lower doping concentrations, e.g. 0.1% and 0.2%, can be useful if a longer gain medium is required in the laser design, e.g. for efficient cooling of the gain material. At the lower doping concentration (0.1%), the absorption coefficient can be less than 0.223 cm-1, assuming that the absorption coefficient is proportional to the doping concentration (FIG. 16B). However, the lower absorption coefficient due to the activated Pr³⁺ requires an absorption coefficient (optical loss) lower than 0.150 cm-1 at 520 nm (FIG. 24A) to obtain lasing. This reduction of the optical loss requires so much effort in engineering the process that a 0.2% lower level of doping concentration should be appropriate. Thus, x should be between 0.2 and 1. Regarding the range of y, as shown in FIG. 16B, the concentration of buffer ions in the range of 3% to 10% was demonstrated. Regarding the lower limit, it was confirmed that 0% buffer ions did not lead to the activation of Pr³⁺ ions. In the case of lower Pr³⁺ concentration, such as 0.2% (the lower limit of Pr³⁺ doping), a 2% concentration of buffer ions is considered sufficient. Therefore, the lower limit of y can be set to 2. Regarding the upper limit, more than 10% concentration of buffer ions would work to activate the doping. However, the addition of more buffer ion results in a decrease of the thermal conductivity. This decrease in thermal conductivity is not desirable in a gain material. Therefore, the practical upper limit can be set to 10%. Thus, a range of 2<y<10 can be set.

The RE³⁺ in the ceramic material system can be a single RE³⁺ or any combination of RE³⁺ among Lu³⁺, Y³⁺, Gd³⁺, and La³⁺. For example, the ceramic material composition can be 0.5% Pr³⁺,5% Y³⁺: SrF₂ or 0.5% Pr³⁺,2.5% Y³⁺,2% Lu³⁺,0.5% La³⁺: SrF₂.

### Crystal Structure

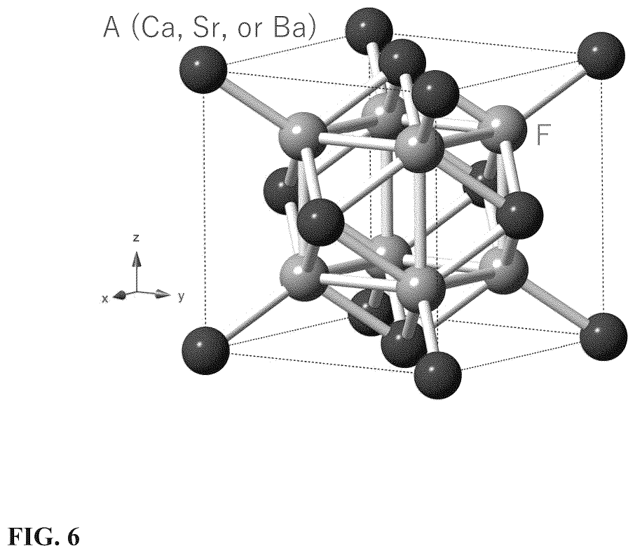

As noted, CaF₂, SrF₂ and BaF₂ have the same face-centered cubic crystal structure, called “fluorite structure”. FIG. 6 is a diagram of the alkaline-earth metal fluoride AF₂ (AF₂=CaF₂, SrF₂, or BaF₂) fluorite unit cell. AF₂ crystallizes in the cubic Fm3̅m space group. In the unit cell, each A²⁺ ion is bonded in a cubic geometry to eight equivalent F-ions, while each F-ion is bonded to four equivalent Sr²⁺ ions in the shape of a tetrahedron.

Fabrication of Ceramics from Powders

The visible laser ceramics can be fabricated through pressure-assisted processing (compression) and sintering of synthesized ceramic powders. The ceramic powders can be synthesized through wet-chemistry precipitation methods. The pressure-assisted processing includes, but is not limited to, dry pressing, cold isostatic pressing, hot pressing, spark plasma sintering, hot isostatic pressing, or a process that includes two or more of these pressure-assisted processings. To induce an anisotropic property in a ceramic, it is preferable to use a pressure-assisted processing that includes at least one uniaxial pressure-assisted processing technique such as dry pressing, hot pressing, and spark plasma sintering. The sintering process includes, but is not limited to, hot pressing, spark plasma sintering, vacuum sintering, sintering in air, sintering in an inert atmosphere, and hot isostatic pressing. The uniaxial pressure-assisted processing and sintering can be performed simultaneously using one technique, such as hot pressing and spark plasma sintering.

### Anisotropy in Optical Scattering in a Ceramic Caused by Directional Processing Pressure

Lyberis et al. pointed out the strong uniaxial character of CaF₂—SrF₂—YbF₃ transparent ceramics prepared via uniaxial hot forming/pressing of 0.65CaF₂—0.30SrF₂—0.05YbF₃ single crystals grown by the Bridgman technique. Lyberis et al. suggested that the strong uniaxial character could be avoided through uniaxial hot pressing of powders instead of single crystals, but the details of uniaxial character were not clarified.

In the following embodiments for a laser application, a uniaxial characteristic caused by directional processing pressure is found and described in alkaline-earth metal fluoride ceramics fabricated via pressure-assisted processing of synthesized powders. How to identify and utilize the uniaxial character caused by directional processing pressure is also disclosed.

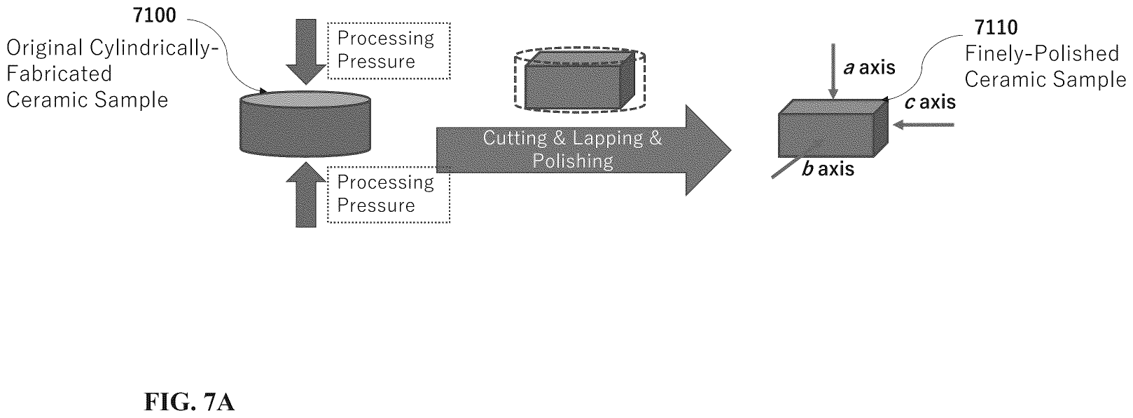

In an embodiment, visible laser ceramics according to the disclosure have a uniaxial high transmissivity. Here we assume the transmissivity along the α axis is higher than that along the b axis or the c axis, which is perpendicular to the α axis. FIG. 7A shows a schematic process flowchart of shaping a cylindrically-fabricated ceramic into a cuboid-shaped ceramic, which illustrates the three (a, b, and c) axes of the visible laser ceramic in the cuboid shape. As described above, a uniaxial pressure-assisted processing technique is necessary for the fabrication of visible laser ceramics. The uniaxial pressure-assisted processing technique involves the use of a die and two punches for the application of a uniaxial pressure. The die is a mold with a tunnel, and the shape of the punches must fit into the tunnel. Powders are loaded into the die with the two punches separately inserted from either side of the die to sandwich the powders. A hydraulic pressure is applied to the two punches so that the uniaxial pressure can be applied on the ceramic powders or the formed ceramic. The punches can be cylinder-shaped, which results in the fabrication of a ceramic in a cylinder shape or a disk shape after the uniaxial pressure-assisted processing. The shape of the punches is not limited to cylinder shape. It can be any shape that can enable the loading of the uniaxial pressure on the sample. In FIG. 7A, the fabricated original ceramic 7100 of cylindrical shape is schematically shown, and the directions of the uniaxial pressure are also shown. After the processes of cutting, lapping, and polishing, the resulting, finely-polished ceramic 7110 can be, for example, of a cuboid shape. The finely-polished ceramic of cuboid shape can be installed in a laser system of the invention as a visible laser ceramic. The shape is not limited to the cuboid shape. Any shape including a cylindrical shape is acceptable, as long as it can be held securely in a cooling holder to be installed in a laser system of the invention. Furthermore, the optical faces of the shape can have a Brewster-angle or can have an anti-reflection coating. As disclosed below, a ceramic fabricated via at least one uniaxial pressure-assisted processing has its lowest scattering axis along the direction of the applied uniaxial pressure. Therefore, it is important to identify the low scattering or low-loss axis of the fabricated ceramic and to align the axis appropriately for a laser oscillation or amplification configuration. In the case of FIG. 7A, the α axis in the visible laser ceramic is along the processing pressure direction. The b and c axes in the visible laser ceramic are in a plane perpendicular to the processing pressure direction. The a axis is to be used for the light path for laser oscillation or amplification in the laser system.

Hereafter, an exemplified embodiment is disclosed. The processing of the visible laser ceramics in the present embodiment is described more specifically using an exemplified example ceramic of constitution chemistry 0.5% Pr³⁺,5% Y³⁺: SrF₂. However, the present embodiment is not limited to this example.

### Example of Powder Synthesis for Visible Laser Ceramics

The 0.5% Pr³⁺,5% Y³⁺: SrF₂ powders were synthesized via a wet-chemistry precipitation method. First, Sr(NO₃)₂, Y(NO₃)₃·6H₂O, and Pr(NO₃)₃·6H₂O were added into deionized (DI) water, strictly based on the stoichiometry of 0.5% Pr³⁺,5% Y³⁺: SrF₂. After stirring and dissolving, the aqueous solution of strontium nitrate, yttrium nitrate, and praseodymium nitrate (Solution 1) was prepared. Meanwhile, an aqueous solution of hydrogen fluoride (HF) acid (Solution 2) was prepared by adding HF acid (40% or 48%) into DI water. Second, Solution 1 was added into Solution 2 directly, and milky precipitates were immediately formed through the wet-chemistry precipitation. After an aging process, the precipitates were then washed through a washing cycle that included centrifuging and dispersing via ultrasonicating. Lastly, the washed precipitates were dried to obtain a dry powder.

In the above-described procedure for synthesizing 0.5% Pr³⁺,5% Y³⁺: SrF₂ powders, the source of strontium can be strontium nitrate, strontium hydroxide, strontium chloride, strontium acetate, or strontium carbonate. The amount of the strontium source can range from 0.02 to 0.3 mol. The source of yttrium can be yttrium nitrate, yttrium hydroxide, yttrium chloride, yttrium acetate, or yttrium carbonate. The amount of the yttrium source can range from 0.001 to 0.015 mol. The source of praseodymium can be praseodymium nitrate, praseodymium hydroxide, praseodymium chloride, praseodymium acetate, or praseodymium carbonate. The amount of the praseodymium source can range from 0.000105 to 0.001575 mol. The source of fluorine can be potassium fluoride, hydrofluoric acid, ammonium fluoride, potassium hydrogen fluoride, or ammonium hydrogen difluoride. The amount of the fluorine source can range from 0.02 to 2 mol. The DI water amount can range from 100 to 1000 mL in Solution 1 and Solution 2, respectively. The time of stirring and dissolving can range from 5 to 30 minutes. The time of the aging process can range from 8 to 72 hours. The washing cycle of the precipitates can be repeated 2 to 7 times. The centrifuging speed can range from 1000 to 10000 rpm, and the centrifuging time can range from 10 to 60 minutes. The ultrasonicating time can range from 10 to 60 minutes. The powder drying method can be drying in air, drying in a protective atmosphere (nitrogen or argon), vacuum drying, freeze drying, or spray drying. The powder drying time can range from 8 to 96 hours.

### Example of Fabrication of a Visible Laser Ceramic from Synthesized Powders

A highly transparent 0.5% Pr³⁺,5% Y³⁺: SrF₂ ceramic was fabricated via pressure-assisted processing of the above-described synthesized powders, such as hot pressing of the powders. The dried powders were loaded into a hollow cylinder-shaped graphite die, with two cylinder-shaped graphite punches separately inserted into the die from either side. The set of graphite die and punches with the loaded powders was placed in a vacuum hot press furnace for hot pressing. The temperature of the furnace was then heated under a protective atmosphere, while a uniaxial mechanical pressure was gradually applied to the sample by employing hydraulic pressure through the cylinder-shaped punches. The uniaxial pressure reached a maximum at the maximum temperature. After that, a dwell time was applied at the maximum temperature for several hours, and the uniaxial pressure remained at the maximum during the dwelling process. After the dwelling process, the furnace was cooled down to room temperature naturally, and the uniaxial pressure was immediately released. Finally, after the cooling process, the ceramic sample was taken out of the graphite die, and a highly transparent 0.5% Pr³⁺,5% Y³⁺: SrF₂ ceramic with a cylindrical shape was thus fabricated.

In the above-described procedure for fabricating a visible laser ceramic from chemically synthesized powders, the protective atmosphere of the sintering process can be a vacuum ranging from 0.0001 Pa to 0.01 Pa or an inert atmosphere. The sintering temperature can range from 600 to 1000° C. The sintering dwell time can range from 0.5 to 6 hours. The sintering heating rate can range from 2 to 100° C./min. The uniaxial pressure can range from 10 to 300 MPa. The shape of the die and punches can be any shape that can enable the loading of the uniaxial pressure on the sample. The material of the die and punches can be graphite, steel, alloy steel, molybdenum tungsten alloy, tungsten carbide, or silicon carbide.

The pressure-assisted processing is not limited to hot pressing. It can involve dry pressing, cold isostatic pressing, hot pressing, spark plasma sintering, hot isostatic pressing, or a combination of two or more of these pressure-assisted processes. The pressure-assisted processing should include at least one uniaxial pressure-assisted processing such as dry pressing, hot pressing, and spark plasma sintering. The ceramic fabrication process should include at least one sintering process, such as hot pressing, spark plasma sintering, vacuum sintering, sintering in air, sintering in an inert atmosphere, and hot isostatic pressing.

### Example of a Fabricated Visible Laser Ceramic

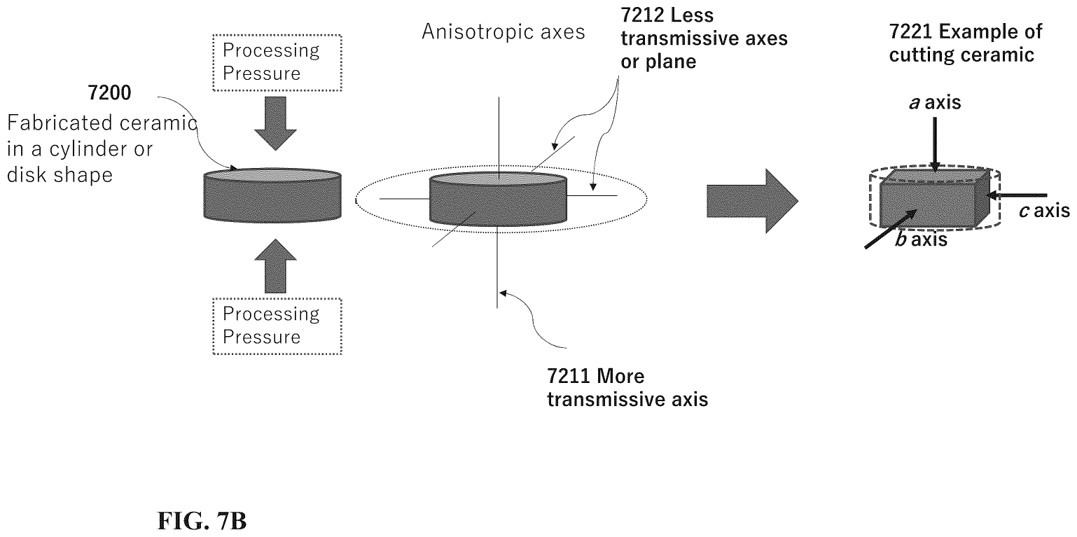

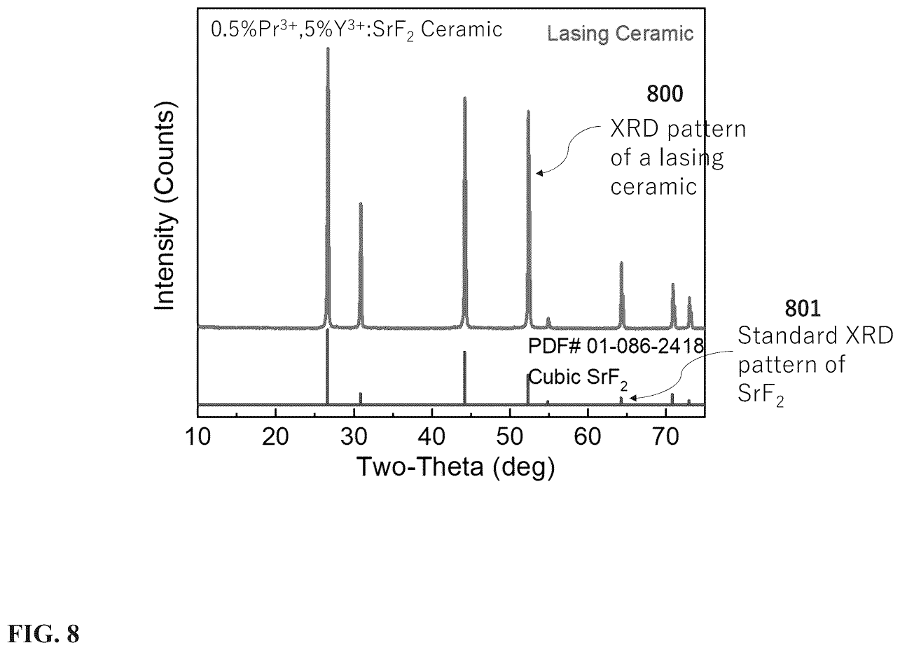

FIG. 8 shows the x-ray diffraction (XRD) pattern of a visible laser ceramic, for example, a SrF₂-based visible laser ceramic (composition: 0.5% Pr³⁺,5% Y³⁺: SrF₂) fabricated according to the disclosed fabrication method. It is shown that the XRD pattern 800 of the ceramic matches well with the standard SrF₂ XRD pattern 801. It can be confirmed that the visible laser ceramic is primarily composed of SrF₂ fluorite phase, which has an isotropic, cubic crystal structure.

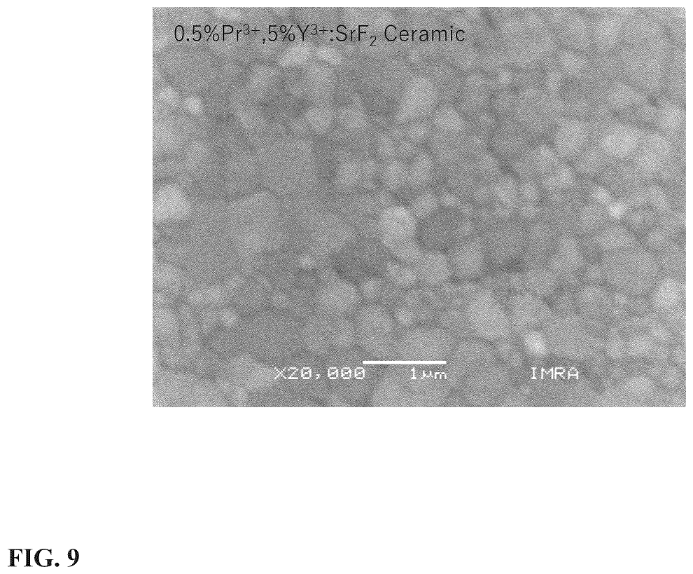

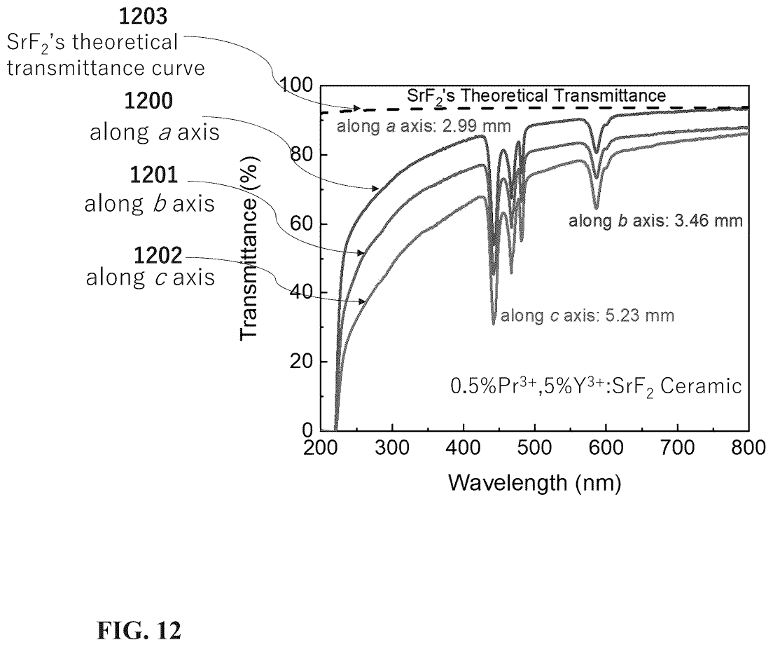

FIG. 9 shows the scanning electron microscope (SEM) image of the surface of a visible laser ceramic. It is shown that the ceramic is almost fully densified, such that few pores are observed. The sufficient densification of the ceramic leads to excellent optical transmittance in the ceramic. It should be noted that a limited amount of very small residual pores (below the SEM resolution limit) may be present in the ceramic. These very small residual pores serve as the optical scattering sources contributing to the gradual decrease of the transmittance at lower wavelengths, as observed in the transmittance curves shown later in FIG. 12. Also, as exemplified in FIG. 9, the grain size of the visible laser ceramic is in the range from 20 nm to 800 nm.

### Example of Cutting, Lapping and Polishing a Fabricated Visible Laser Ceramic

The cylinder-shaped, highly transparent 0.5% Pr³⁺,5% Y³⁺: SrF₂ ceramic was first cut and polished to a cuboid-shaped ceramic. The cuboid-shaped ceramic was further Brewster-angle cut using polishing jigs, and then finely polished through optical-grade polishing using a combination of polishing films and slurries with various polishing grits.

In the above method, the polishing films used in the polishing process can be silicon carbide polishing films, diamond polishing films and alumina polishing films. The polishing slurries used in the polishing process can be diamond polishing slurries, alumina polishing slurries, and ceria polishing slurries. The polishing grits can range from 30 to 0.05 μm.

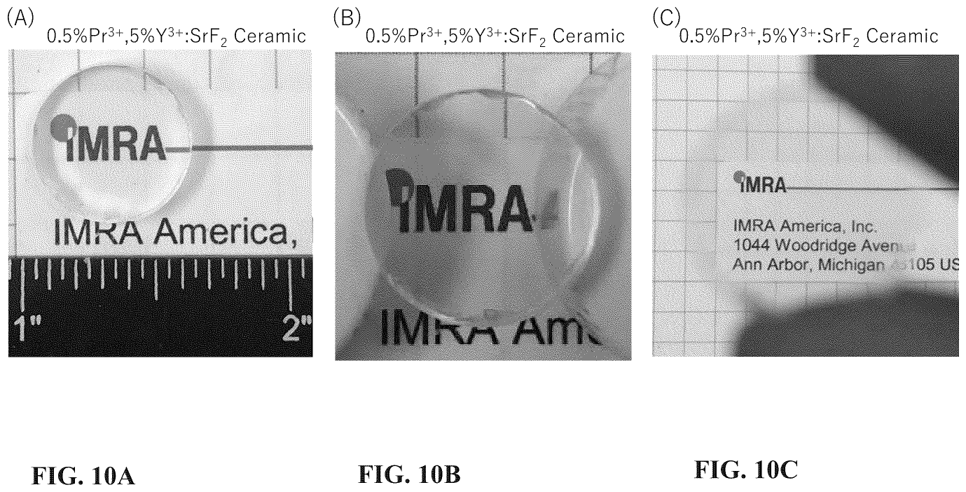

FIG. 10A-FIG. 10C are a series of photos of the highly transparent, originally cylindrically-fabricated ceramic (composition: 0.5% Pr³⁺,5% Y³⁺: SrF₂; thickness along the α axis: 3.99 mm; polished with 1 μm diamond polishing films and slurries) with various distances ((A): 0 mm; (B): 11 mm; (C): 210 mm) along the α axis from the sample to a printed worded paper placed underneath. It is observed that the polished original ceramic with a thickness of 3.99 mm is highly transparent along the α axis, even with a relatively long distance from the sample to the worded paper.

To make a cylinder-shaped ceramic into a cuboid shape with all surfaces optically finished, the other two pairs of parallel surfaces, which are perpendicular to either of the b or c axes, can be cut and polished in the same way as the pair of surfaces perpendicular to the α axis.

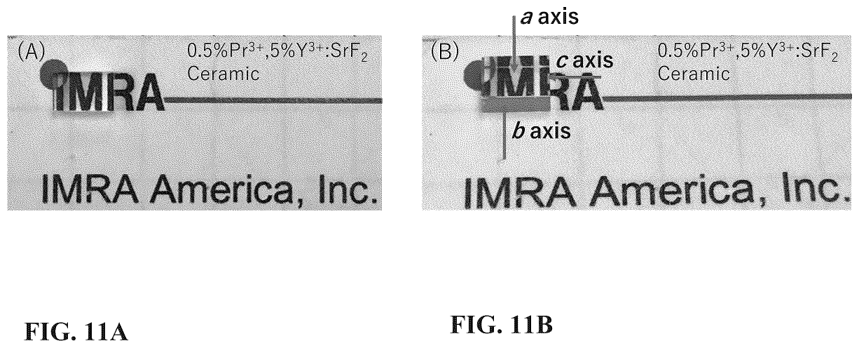

FIG. 11A is a photo of the finely-polished visible laser ceramic composition: 0.5% Pr³⁺,5% Y³⁺: SrF₂; shaped according to the process flowchart in FIG. 7A. FIG. 11B shows the a, b, and c axes (thickness along the α axis: 2.99 mm; thickness along b axis: 3.46 mm; thickness along c axis: 5.23 mm). It should be noted the highly transparent ceramic shown in FIG. 11 has a cuboid shape, and it corresponds to the finely-polished visible laser ceramic 7110 with the notes of the corresponding axes in FIG. 7A.

### Example of the Transmittance, Scattering, and Absorption Properties of the Visible Laser Ceramic

FIG. 12 displays the in-line transmittance spectra of the visible lasing ceramic (shown in FIG. 11) along a, b, and c axes (with SrF₂'s theoretical transmittance curve as a comparison). It is noted that SrF₂'s theoretical transmittance is calculated using the following equation:

$${T}_{t} = {( 1 - R ( λ ) )}^{2} = {( 1 - {( \frac{n ( λ ) - 1}{n ( λ ) + 1} )}^{2} )}^{2}$$

where R(λ) is SrF₂'s reflectivity at a certain wavelength λ, and n(λ) is the value of SrF₂'s refractive index at a certain wavelength λ.

It is shown that the transmittance curve along the α axis 1200 is closest among all the three axes to the theoretical transmittance curve of SrF₂ 1203, which is attributed to the combined effect of smaller thickness and higher uniaxial transmissivity. The transmittance of the visible lasing ceramic along the α axis in the visible range is over 90%, and it is nearly the same as the theoretical transmittance of SrF₂ crystal in the wavelength range of 700-800 nm. This further suggests excellent densification and optical quality in the visible lasing ceramic along the α axis. The gradual decrease of the transmittance values at shorter wavelengths can be attributed to the presence of very small residual pores within the ceramic.

The absorption coefficient provides a more direct insight into the comparison in transmissivity with various lengths/thicknesses of the optical path. In the case where there are no dopant-induced absorptions in the transmittance spectra, the absorption coefficient can be basically regarded as a measure of the optical scattering loss within the finely polished ceramic. Thus, an absorption coefficient at a wavelength where no dopant-induced absorption occurs can be used as a measure to evaluate anisotropic optical scattering properties, more specifically, the axis-dependent scattering loss in a ceramic made by uniaxial pressure-assisted processing, is exemplified in the following embodiment. Based on the data shown in FIG. 12, the absorption coefficient (cm⁻¹) is calculated using the following equation, where the influence of Fresnel reflection is eliminated:

$$α ( λ ) = - \frac{1}{d} ln ( \frac{T ( λ )}{{( 1 - R ( λ ) )}^{2}} )$$

where α is the absorption coefficient at a certain wavelength λ, d is the thickness in centimeters, T(λ) is the in-line optical transmittance at a certain wavelength λ, and R(λ) is the sample's reflectivity at a certain wavelength λ.

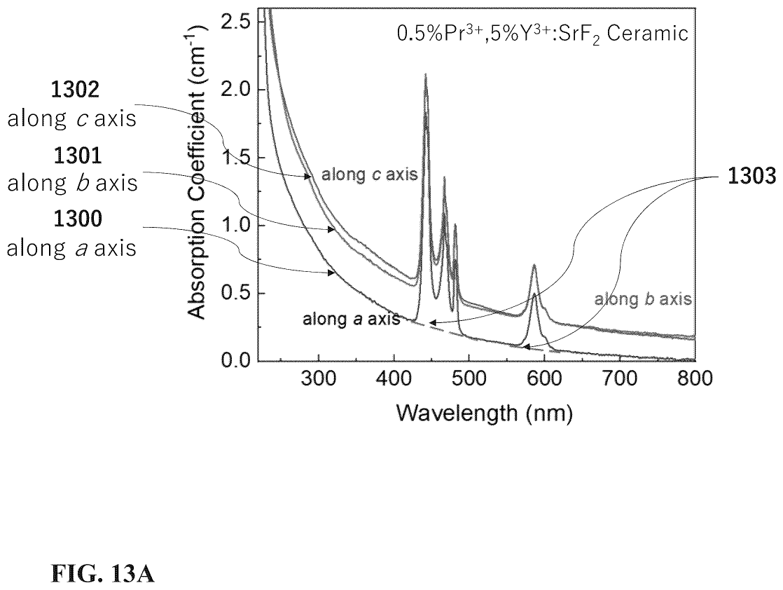

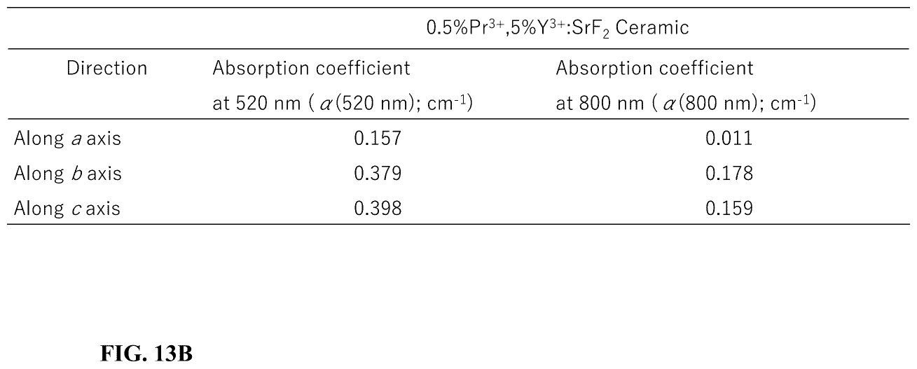

FIG. 13A displays the absorption coefficient spectra of the visible laser ceramic (composition: 0.5% Pr³⁺,5% Y³⁺: SrF₂) along a, b, and c axes. More specifically, FIG. 13B summarizes the absorption coefficients at 520 nm (a (520 nm)) and 800 nm (a (800 nm)) of the visible laser ceramic composed of 0.5% Pr³⁺,5% Y³⁺: SrF₂. The absorption coefficients have low values in the wavelength ranges from 480 nm to 560 nm, and from 620 nm to 800 nm, in the visible region, indicative of good transmissivity and low optical scattering of the ceramic. For example, as summarized in FIG. 13B, the absorption coefficients at 520 nm are lower than 0.4 cm⁻¹, and those at 800 nm are even lower than 0.2 cm⁻¹. Based on the curves of an absorption coefficient along various axes, it is clearly shown that the αₐ 1300, the absorption coefficient along the a-axis, is generally smaller than α_{b} 1301, the absorption coefficient along b-axis, or α_{c} 1302, the absorption coefficient along c-axis, at the same wavelength, for example at 520 nm or at 800 nm, as shown in FIG. 13B. This indicates that the transmissivity along the α axis is higher than that along b or c axes. At 520 nm, the αₐ 1300 is smaller than 50% of α_{b} 1301 or ac 1302. At 800 nm, the αₐ 1300 is even smaller than 10% of α_{b} 1301 or α_{c} 1302. As shown in FIG. 7B, the ceramics fabricated using uniaxial pressure-assisted processing are expected to have a uniaxial anisotropy in the optical transmittance, such as the apparent absorption coefficient caused by light scattering. On the other hand, in the radial directions, namely in the 7212 “Less transmissive plane” in FIG. 7B, which is perpendicular to the uniaxial pressure axis (7211 “More transmissive axis” in FIG. 7B), the absorption coefficients are expected to be a similar if a cylindrical-shaped die is used. The anisotropic absorption coefficient spectra in FIG. 13 appropriately demonstrates the uniaxial high transmissivity in the visible laser ceramic in the exemplified embodiment. Therefore, it is concluded that the visible laser ceramic has an anisotropic transmissivity or optical scattering property, which is correlated with the uniaxial press-assisted processing. In the exemplified embodiment, the axis a (the direction of the lowest absorption or scattering) can be aligned parallel to the optical path in a laser cavity or laser amplifier as in FIG. 4 or FIG. 5 discussed above.

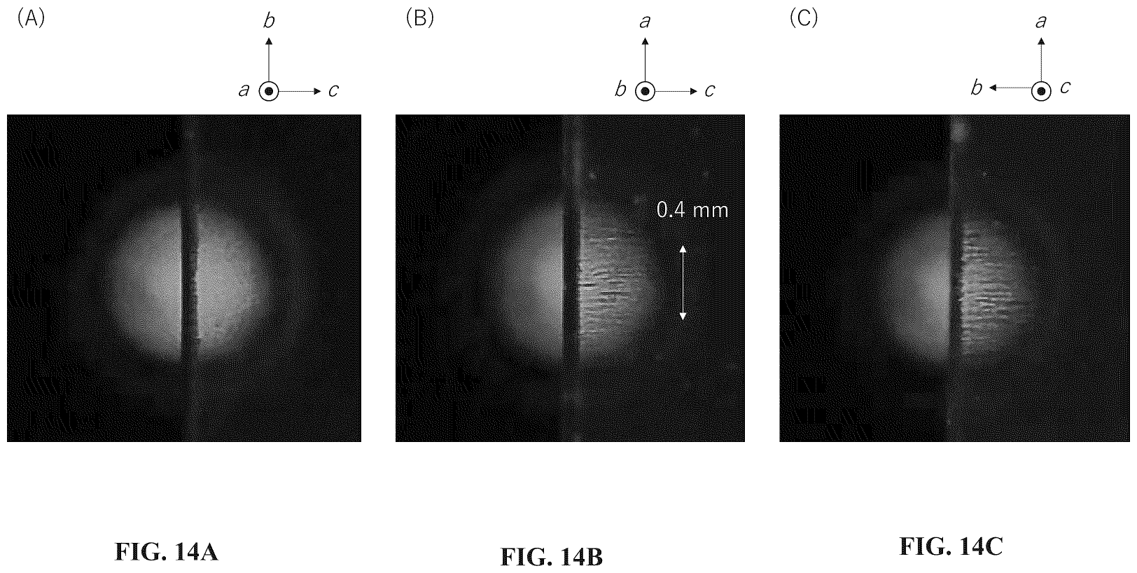

In order to further clarify the transmission anisotropy, the images of a green laser spot observed through the ceramic sample along various axes are shown in FIGS. 14A, 14B, and 14C. By observing both of the half laser spots through the sample and the other half (not passing through the sample), the effect happening inside the samples can be elucidated. FIG. 14A indicates the case where the α axis was parallel to the propagation direction of the green laser. As can be seen, the laser spot was uniformly modified by the scattering sources inside the sample. On the other hand, when the b axis (FIG. 14B) or the c axis (FIG. 14C) was parallel to the laser propagation direction, characteristic stripe-like patterns (striae) were observed. The directions of both stripes were parallel to the plane formed by the b and c axes (b-c plane). The interval of the stripes was estimated to be about 30 μm from the scale in FIG. 14B.

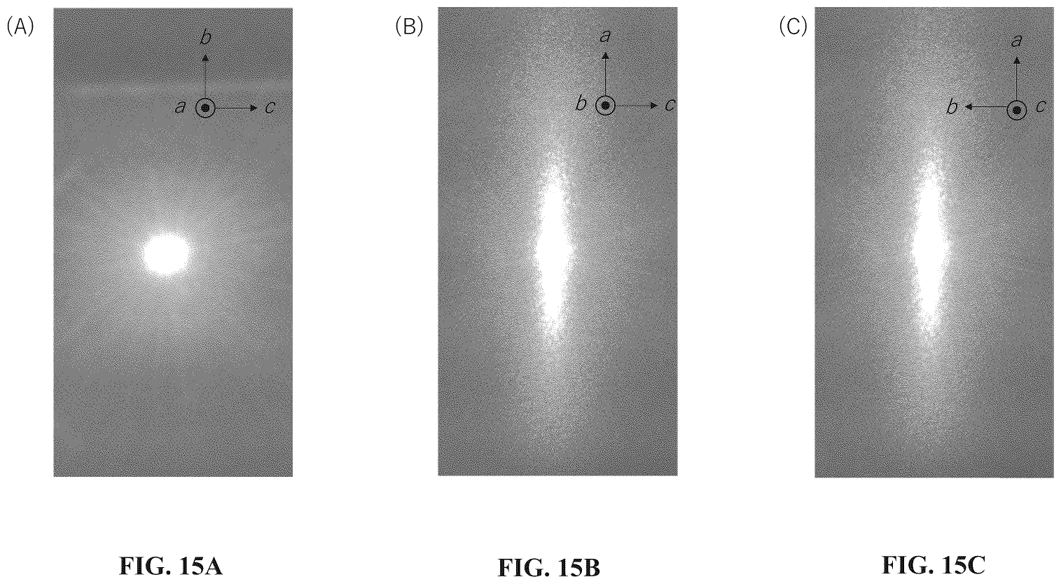

For the purpose of investigating the effect of the stripes when used in a laser, the change of the laser spot, which had originally a circular shape, after transmission through the sample along various axes were compared (FIG. 15A, FIG. 15B, and FIG. 15C). When the laser is passing through the sample along the α axis (FIG. 15A), the laser beam was almost isotopically scattered in radial directions, reflecting the original laser spot shape. On the other hand, as shown in FIG. 15B and FIG. 15C, the laser spots on the screen were largely elongated in the vertical direction, which is perpendicular to the b-c plane. This diverging effect is caused by a larger optical scattering loss in directions perpendicular to the α axis. The diverging effect in almost only one direction parallel to the α axis in FIG. 15B and FIG. 15C can be attributed to optical diffraction due to the stripes inside the ceramic. Thus, for a laser use, it is preferable to avoid the b axis, c axis, or other axes close to being parallel to the b-c plane and to use the α axis as the direction of laser oscillation or amplification path. The larger optical scattering loss along the b or c axis is consistent with the transmissivity data (FIG. 12). It was demonstrated that the uniaxial scattering property of the laser ceramic (the stripe-like patterns (striae) along the b-c plane observed in FIG. 14B and FIG. 14C) affects the laser especially when the directions of the laser are parallel to the b or c axis. Thus, the directions of the α axis or near α axis are preferable for its use in the laser or laser pulse amplifier.

This anisotropic transmissivity or optical scattering property of fabricated ceramics is relevant to the uniaxial pressure-assisted processing, and needs to be carefully considered for successful visible laser oscillation. In turn, this property can be made use of for preventing parasitic lasing or amplified spontaneous emission (ASE), which can occur and potentially reduce the gain for lasing and pulse amplification efficiency in an intended laser direction in the case of isotropic gain materials. In the visible laser ceramics, parasitic lasing in unintended directions can be avoided with an appropriate alignment of the low-loss axis.

To use a gallium nitride based blue diode laser with a wavelength around 444 nm for the excitation of a Pr³⁺-doped visible laser ceramic in a laser oscillator or in a laser amplifier, an efficient absorption around 444 nm induced by doped Pr³⁺ ions is also of importance. Based on the data shown in FIG. 13A, the Pr³⁺-activated absorption coefficient (cm⁻¹) at 444 nm is calculated using the following equation, which approximately eliminates the influence of the optical scattering at 444 nm within the ceramic:

$$α ( {Pr}^{3 +} ) = α ( 444 nm ) - {α}_{s} ( 444 nm )$$

where α(Pr³⁺) is Pr³⁺-activated absorption coefficient at 444 nm, a (444 nm) corresponds to the absorption coefficient at 444 nm, and as (444 nm) corresponds to the optical scattering (optical loss) coefficient at 444 nm. The value of as (444 nm) is approximately calculated based on the absorption spectra 1300, 1301 and 1302 in FIG. 13A of the ceramic for each axis. For example, the as (444 nm) along the α axis is drawn as the curve 1303 in the absorption spectra.

FIG. 16A summarizes the Pr³⁺-activated absorption coefficients α(Pr³⁺) at 444 nm of the visible laser ceramic shown in FIG. 13A (composition: 0.5% Pr³⁺,5% Y³⁺: SrF₂) along a, b, and c axes.

FIG. 16B summarizes the Pr³⁺-activated absorption coefficients along the α axis at 444 nm of the active ceramics composed of Pr³⁺: SrF₂ co-doped with Y with various concentrations of Y and Pr different from 0.5% Pr³⁺,5% Y³⁺: SrF₂. These additional examples show that the Pr³⁺-activated absorption coefficient can be modified by adjusting the concentration of the dopants in the ceramics fabricated according to the disclosed processes.

### Other Examples of the Transmittance, Scattering, and Absorption Properties of Active Fluoride Ceramics with Various Co-Doped Trivalent RE Ions

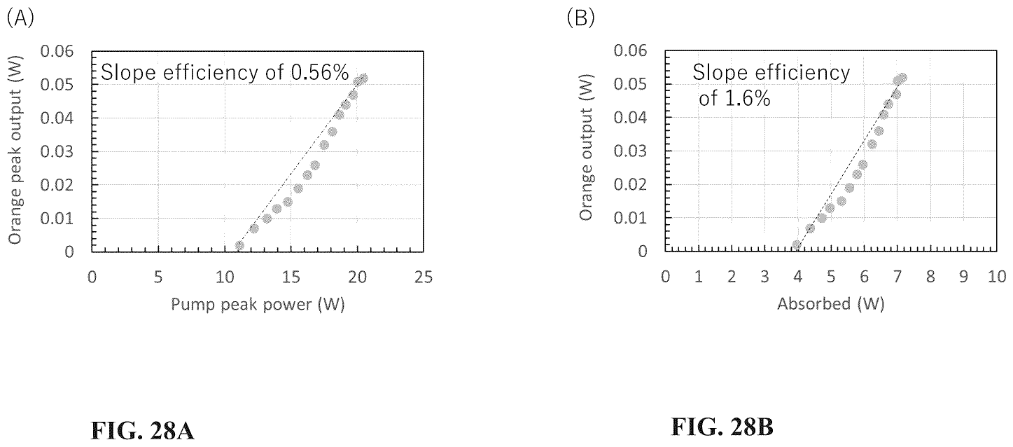

FIG. 16C displays the absorption coefficient (along the α axis) spectra of other ceramic samples with different co-doped RE elements including: Pr: SrF₂ co-doped with Gd (0.5% Pr³⁺,5% Gd³⁺: SrF₂), Pr: SrF₂ co-doped with La (0.5% Pr³⁺,5% La³⁺: SrF₂), and Pr: SrF₂ co-doped with Lu (0.5% Pr³⁺,5% Lu³⁺: SrF₂). FIG. 16D summarizes the absorption coefficients along the α axis at 520 nm (aa (520 nm)) and 800 nm (aa (800 nm)) of the ceramics, as a measure of scattering loss in the ceramics. All the absorption coefficients along the α axis are relatively small in the visible wavelength range, suggesting good optical transmittance of the ceramics. The αₐ of the sample of Pr: SrF₂ co-doped with Gd 1600 and the αₐ of the sample of Pr: SrF₂ co-doped with Lu 1602 are smaller than that of Pr: SrF₂ co-doped with La 1601. It is also found that αₐ (520 nm) and αₐ (800 nm) of the ceramics with co-doped RE element of Gd, La, and Lu (as shown in FIG. 16D) are slightly larger than those of the ceramics with the co-doped RE element of Y(as shown in FIG. 13B). The absorption coefficients of the ceramics in the exemplified embodiments can be further adjusted through adjustments to the material composition and fabrication process, to be more suitable for laser operation. For visible laser ceramics, αₐ (520 nm) can preferably be in a range from 0.001 cm⁻¹ to 0.5 cm⁻¹, and more preferably in the range from 0.005 cm⁻¹ to 0.4 cm⁻¹, and most preferably in the range from 0.05 cm⁻¹ to 0.3 cm⁻¹, and αₐ (800 nm) can be preferably in the range from 0.001 cm⁻¹ to 0.15 cm⁻¹, and more preferably, in the range from 0.005 cm⁻¹ to 0.125 cm⁻¹, and most preferably in the range from 0.01 cm⁻¹ to 0.1 cm⁻¹. The absorption coefficient at 520 cm⁻¹ ranges were determined based on considerations listed as follows. The laser was demonstrated and the slope efficiency was 1.6%, and the threshold pump was 4 W (FIG. 28B) in the gain material whose absorption (scattering loss) coefficient was 0.150 cm⁻¹ at 520 nm (FIG. 24A). In the laser, there are several causes of the loss (such as reflection loss in the surface of the gain material due to the imperfection of the Brewster angle arrangement or the polishing quality), but for simplicity, the loss is assumed to be mainly from the scattering loss of the gain medium. It is also assumed that the absorption coefficient at 605 nm is close to that at 520 nm. In this case, the slope efficiency is proportional to l (=absorption coefficient × the length of the gain material)—In (R) (R is the reflectivity of the output coupler, and in this case, R is 0.99), and the threshold pump is inversely proportional to l-ln (R). Thus, the lower the absorption coefficient of the ceramic, the more preferable it is as a visible laser ceramic. On the other hand, ceramics inevitably contain residual pores as the optical scattering sources that prevent the perfect transmissivity and make it difficult to achieve more transparency. Thus, it is reasonable to set a lower limit of the absorption coefficient. Regarding the upper limit, if we assume the absorption coefficient to be 0.5 cm⁻¹, the threshold pump can be calculated to be 22 W, which is already a large pump power. Also, this scattering loss of 0.5 cm⁻¹ is comparable to the Pr³⁺-activated absorption coefficient (0.667 cm⁻¹) in FIG. 16B, which makes the lasing more difficult. The absorption coefficient ranges at 800 nm were determined using the same considerations.

FIG. 16E summarizes the Pr³⁺-activated absorption coefficients along the α axis at 444 nm of the active ceramics with other RE dopants shown in FIG. 16C. The Pr³⁺-activated absorption coefficient varies among the ceramics with different RE dopants, even though the concentrations of Pr³⁺ and RE³⁺ are the same among the samples. This may be due to the difference in crystal field or local symmetry environment around Pr³⁺ in the ceramics, which is caused by the incorporation of different co-doped trivalent RE ions. For the Pr³⁺-activated ceramics capable of lasing at a visible wavelength, α(Pr³⁺) may be preferably in the range from 0.2 cm⁻¹ to 4 cm⁻¹, more preferably in the range from 0.3 cm⁻¹ to 3.5 cm⁻¹, and most preferably in the range from 0.4 cm⁻¹ to 3 cm⁻¹. The numerical ranges were set based on the following considerations. In FIG. 16B, the Pr³⁺-activated absorption coefficient exhibited the range from 0.667 to 2.389 cm⁻¹ depending on the doping concentration ranging from 0.3% to 0.8%. Depending on the application, it is preferable to control the Pr³⁺-activated absorption coefficient. For example, in the smaller laser design, ceramics with short optical paths are preferred, and to achieve sufficient absorption, larger Pr³⁺-activated absorption coefficients are preferred. For efficient cooling of the material, ceramics with long optical paths and smaller Pr³⁺-activated absorption coefficients are better because the thermal rise in a given area is mitigated. The Pr³⁺-activated absorption coefficient of 2.4 cm⁻¹ can be exceeded if 1% Pr³⁺ doping is selected, based on the control of the concentration and composition of the buffer ions, and the mixing of different buffer ions. On the other hand, at concentrations higher than 1% doping, concentration quenching can suppress the increase of the absorption coefficient. The Pr³⁺-activated absorption coefficient can be lowered by simply decreasing the Pr³⁺ doping concentration. However, if it is too low, the Pr³⁺-activated absorption coefficient could be lower than the scattering loss (in the case of demonstration, it is 0.150 cm⁻¹ at 520 nm). Based on these considerations, the three preference ranges were set.

### Example of the Emission Properties of Active Ceramics

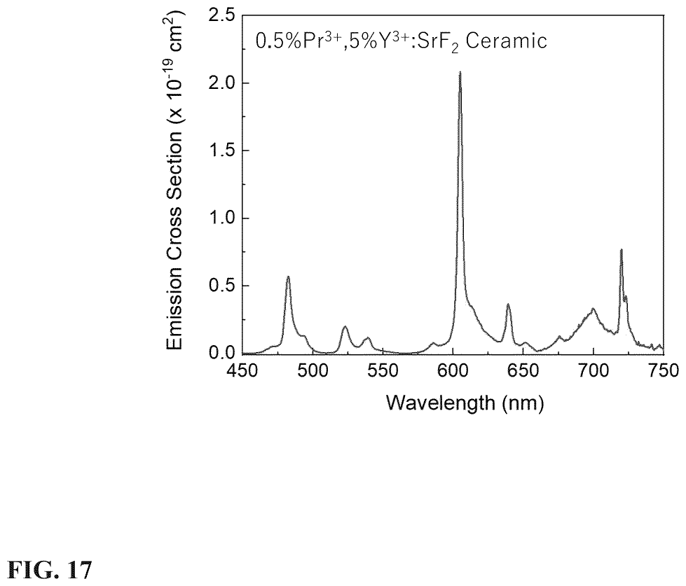

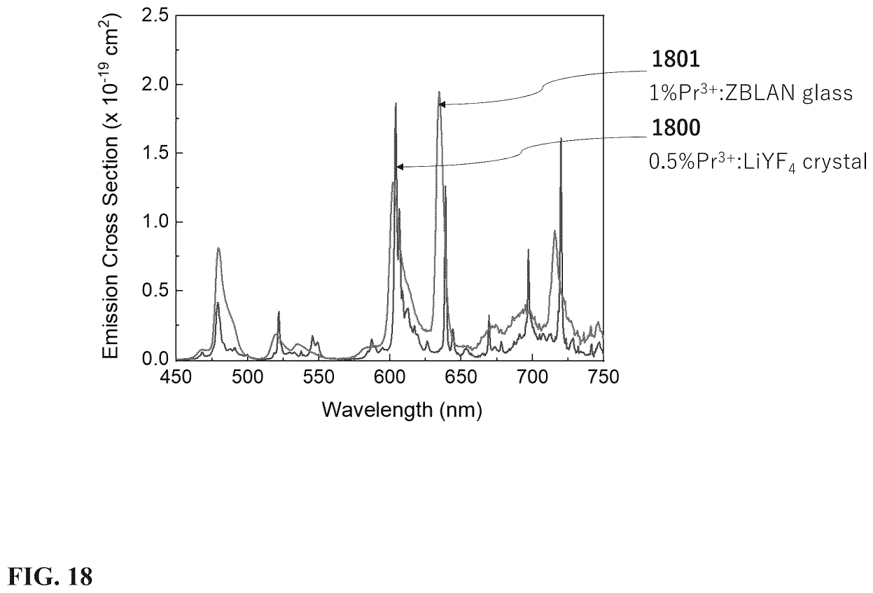

FIG. 17 shows the emission cross section spectrum of a visible laser ceramic sample (composition: 0.5% Pr³⁺,5% Y³⁺: SrF₂) under excitation at 444 nm, estimated by the Füchtbauer-Ladenburg method. FIG. 18 shows the emission cross section spectra of a known 0.5% Pr³⁺: LiYF₄ laser crystal and a known 1% Pr³⁺: ZBLAN laser glass for reference. The ceramic sample has several prominent emission peaks in the visible wavelength range, which are approximately located at 482 nm (blue), 522 nm (green), 605 nm (orange), 639 nm (red), and 720 nm (deep red). The wavelengths and intensities of the visible emission peaks of the ceramic sample are very similar to those of the Pr³⁺: LiYF₄ laser crystal 1800 and the Pr³⁺: ZBLAN laser glass 1801 that are presumably capable of lasing at various visible wavelengths according to the references [1, 4, 10]. The visible emission peaks are attributed to the electron transitions between different energy levels in Pr³⁺, as shown by emissions 301 and their energies in FIG. 3. The emission cross sections of the Pr³⁺: LiYF₄ laser crystal can be polarization-dependent (see reference [2]), which is attributed to the macroscopic anisotropy of a single crystal with a non-cubic crystal structure. In contrast, the visible laser ceramics in the embodiments have polarization-independent emission cross section spectra. This is because these polycrystalline ceramics are composed of randomly-oriented ceramic grains, each of which possess a cubic crystal structure, resulting in a macroscopically isotropic nature.

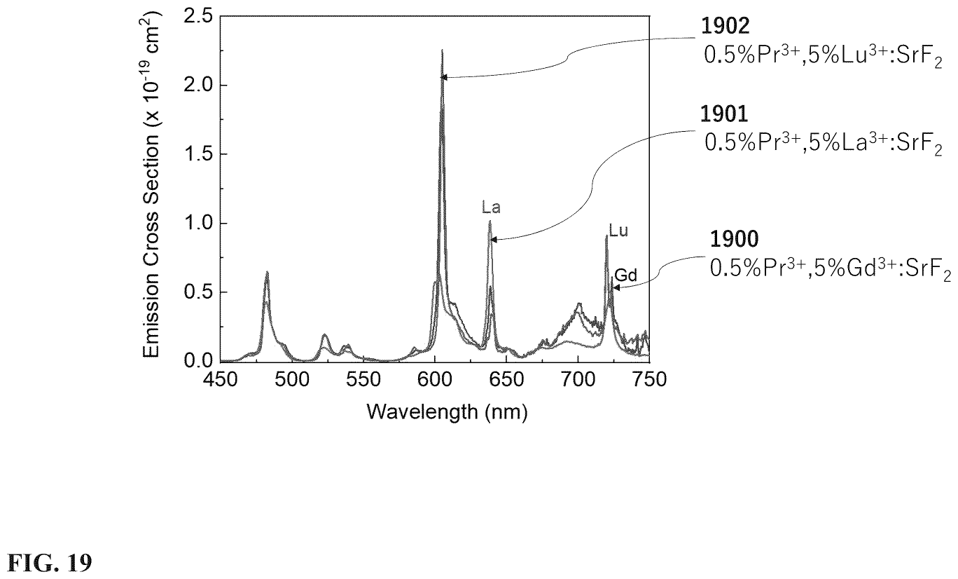

The emission cross section spectra of other ceramics (also under excitation 444 nm) with different RE elements (0.5% Pr³⁺,5% Gd³⁺: SrF₂, 0.5% Pr³⁺,5% La³⁺: SrF₂ and 0.5% Pr³⁺,5% Lu³⁺: SrF₂) are displayed in FIG. 19. The characteristic visible emission peaks are observed at similar wavelengths, compared with the spectra shown in FIG. 17 and FIG. 18, such as around 482 nm (blue), 522 nm (green), 605 nm (orange), 639 nm (red), and 720 nm (deep red). However, the peak intensity can vary in the ceramic samples with various co-doped RE elements. The sample of Pr: SrF₂ co-doped with Gd 1900 and the sample of Pr: SrF₂ co-doped with Lu 1902 exhibit the most intense peak at 605 nm, while the sample of Pr: SrF₂ co-doped with La 1901 exhibits the most intense peak at 639 nm.

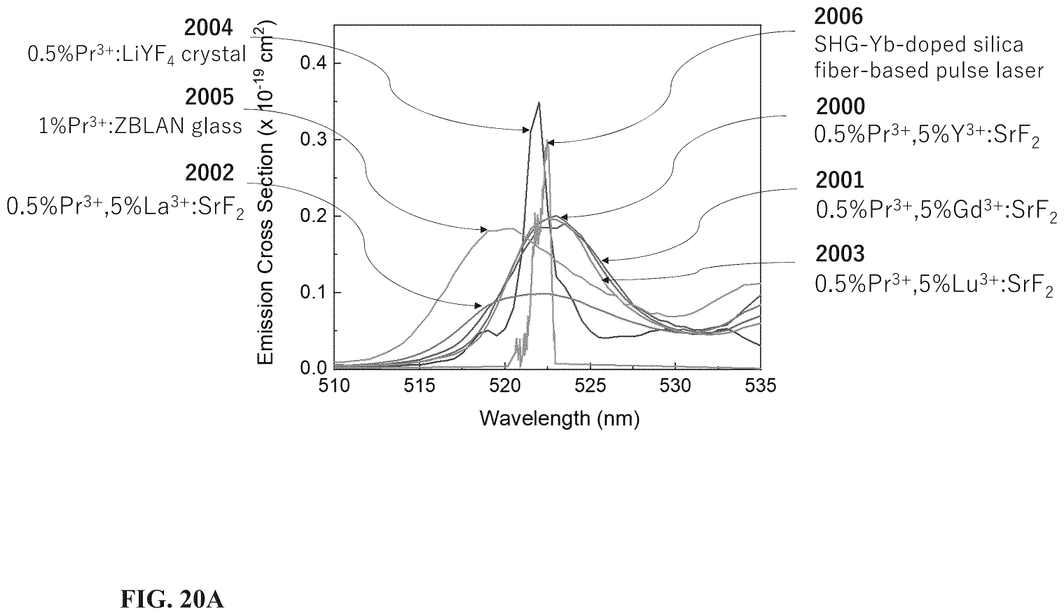

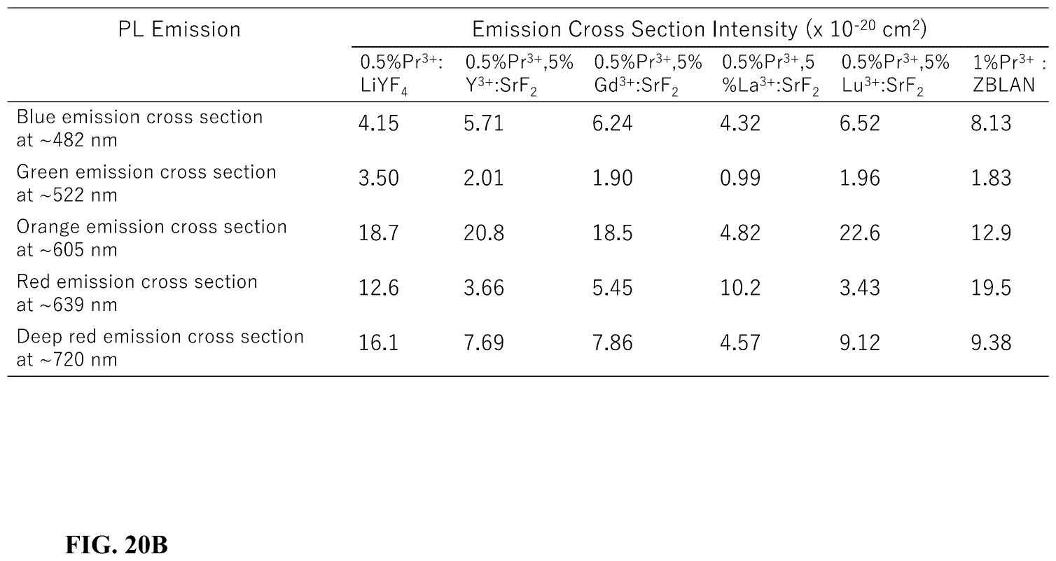

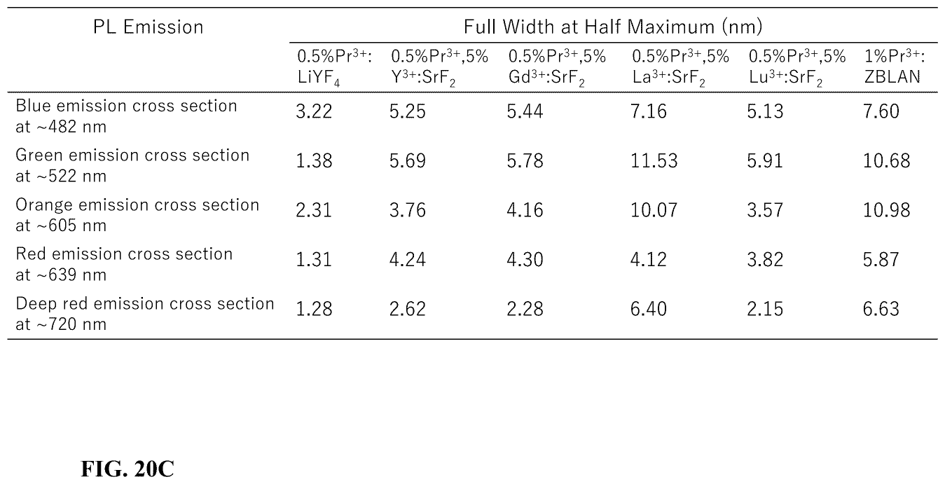

Further detailed investigations have been performed specifically on the green emission in the spectra for green pulse amplification. FIG. 20A displays the emission cross section spectra, in a green region (510-535 nm), of the ceramic samples, the known 0.5% Pr³⁺: LiYF₄ laser crystal, and the known 1% Pr: ZBLAN laser glass, in comparison with a spectrum of the second-harmonic generation (SHG) from a ytterbium (Yb) doped silica fiber-based ultrafast pulse laser. The line widths of emission peaks around 522 nm in the ceramic samples 2000-2003 are broad enough to appropriately cover the spectrum of the SHG pulse from the infrared ultrafast pulse laser 2006. The broad emission spectrum in green is beneficial for ultrafast green pulse amplification. In contrast, based on the comparison between the spectra of SHG-Yb-doped silica fiber-based pulse laser 2006, 0.5% Pr³⁺: LiYF₄ laser crystal 2004, and 1% Pr³⁺: ZBLAN laser glass 2005, it is observed that there are some unfavorable mismatches regarding the spectra overlaps. The emission peak of 0.5% Pr³⁺: LiYF₄ laser crystal 2004 is too narrow to fully cover that of the SHG from the infrared ultrafast pulse laser 2006, while the emission peak of the 1% Pr³⁺: ZBLAN laser glass 2005 is shifted to a shorter wavelength, compared with that in the spectrum of the SHG from the infrared ultrafast pulse laser 2006. These mismatches potentially make the green pulse amplification less efficient.

FIG. 20B specifically summarizes the emission cross section intensities of visible emission peaks in the ceramics fabricated according to the embodiments, the known 0.5% Pr³⁺: LiYF₄ crystal, and the known 1% Pr³⁺: ZBLAN glass. The ceramics exhibit visible emission cross sections with intensities comparable to the 0.5% Pr³⁺: LiYF₄ crystal and the 1% Pr³⁺: ZBLAN glass. It is further shown that the orange emission peak at 605 nm is the strongest in the ceramics of Pr: SrF₂ co-doped with Y, or Gd, or Lu, which values are also similar to that of the 0.5% Pr³⁺: LiYF₄ crystal. In contrast, the red emission peak at 639 nm is the most intense peak in the ceramic Pr³⁺: SrF₂ co-doped with La as well as in the 1% Pr³⁺: ZBLAN glass. Therefore, based on the emission spectra of the ceramics in the embodiments, it is suggested that the lasing wavelength can be tuned by adjusting the material composition of the ceramic, by changing the co-doped RE elements, depending on the wavelength required for laser operation in an intended application. Based on the data shown in FIGS. 17-20, which compare the visible emission cross sections of the exemplified ceramics of Pr: SrF₂ co-doped with various RE elements and the known laser crystal/glass, it is clear that a laser or laser amplifier comprised of a visible laser ceramic as in these embodiments can be competitively capable of laser oscillation or amplification in the wavelength range from 480 nm to 725 nm.

The emission peaks in the active ceramic samples are broader than those in the Pr³⁺: LiYF₄ crystal but narrower than those in the Pr³⁺: ZBLAN glass. FIG. 20C summarizes the full width half maximum (FWHMs) of the characteristic visible emission peaks indicated in FIG. 20B. The FWHMs of the visible emission peaks in the ceramic samples are larger than those in the Pr³⁺: LiYF₄ crystal by a factor of more than 1.5 but smaller than those in the Pr³⁺: ZBLAN glass. The difference in FWHM can be attributed to the difference in the local symmetry environment of Pr³⁺ within polycrystalline ceramic, single crystal, and glass. Compared with the Pr³⁺: LiYF₄ crystal, the broader FWHMs may be more beneficial for highly efficient amplification of visible short pulses. The FWHM of the emission peak around 520 nm in the active ceramics is more than 3 times that in the Pr³⁺: LiYF₄ laser crystal. Preferably, the FWHM of a visible emission peak in the emission cross section spectra of a visible laser ceramic fabricated by the disclosed processes may be in the range from 2 nm to 12 nm.

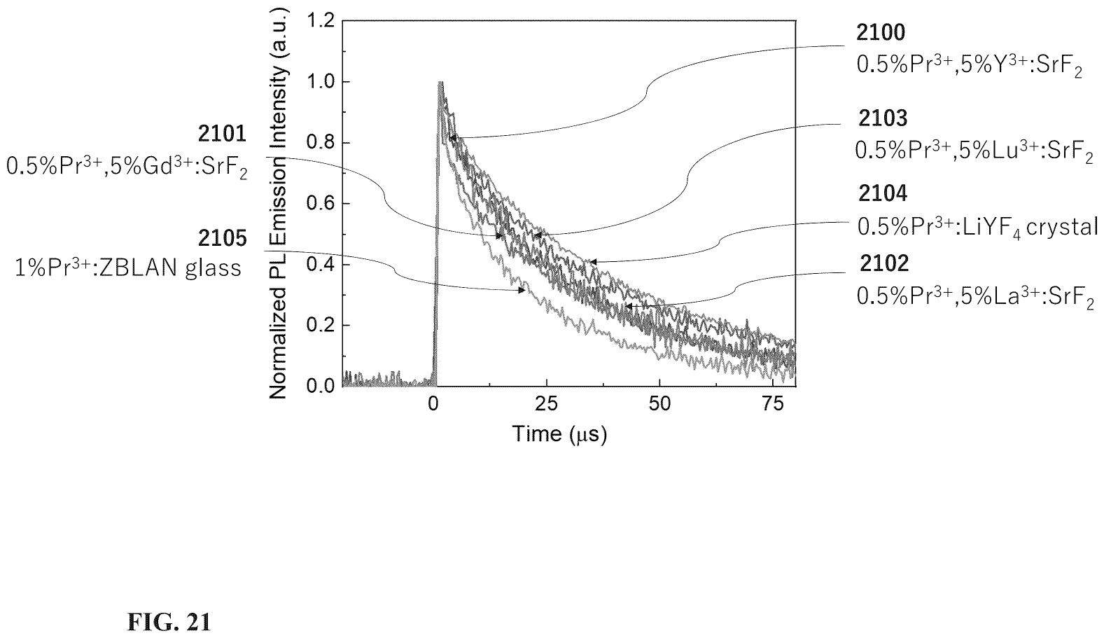

FIG. 21 displays the photoluminescence decay curves of the active ceramic samples, the 0.5% Pr³⁺: LiYF₄ laser crystal, and the 1% Pr³⁺: ZBLAN laser glass for the green emission at 522 nm under the excitation of a blue laser diode with an excitation wavelength of 444 nm. Typical photoluminescence decay characteristics of the green emission are due to the doping of Pr³⁺. The lifetimes are measured as 26.8 us for the sample of Pr: SrF₂ co-doped with Y (0.5% Pr³⁺,5% Y³⁺: SrF₂) 2100, 24.8 us for the sample of Pr: SrF₂ co-doped with Gd (0.5% Pr³⁺,5% Gd³⁺: SrF₂) 2101, 32.8 us for the sample of Pr: SrF₂ co-doped with La (0.5% Pr³⁺,5% La³⁺: SrF₂) 2102, 26.4 us for the sample of Pr: SrF₂ co-doped with Lu (0.5% Pr³⁺,5% Lu³⁺: SrF₂) 2103, 36.8 us for the 0.5% Pr³⁺: LiYF₄ crystal 2104, and 15.6 us for the 1% Pr³⁺: ZBLAN glass 1905. Here, the lifetimes were estimated by the time at which the normalized intensities become approximately 1/e. It is clearly shown that the photoluminescence decay characteristics of the active ceramic samples are comparable to those of 0.5% Pr³⁺: LiYF₄ crystal 2104 and 1% Pr³⁺: ZBLAN glass 2105. This indicates that all sample compositions would be capable of laser oscillation and laser amplification in terms of lifetimes. A preferred lifetime of the green emission for a visible laser ceramic would be in the range of 18 μs to 40 μs.

### Example of the Thermal Conductivity of the Active Ceramics

The thermal conductivity of the ceramics in the embodiments ranges from 1 W/m·K to 8 W/m·K, and it is highly dependent on the doping concentrations of Pr³⁺ and the RE buffer ions. Depending on the doping concentrations, the thermal conductivity of the visible laser ceramics could be lower than that of the LiYF₄ laser crystal (5.8 W/m·K|c; 7.2 W/m·K Lc) [18], but it is superior when compared with the ZBLAN laser glass (0.628 W/m·K) [20].

### Example of Visible Laser Oscillation in Ceramics

An exemplified visible laser system using a visible laser ceramic is disclosed below. The 0.5% Pr³⁺,5% Y³⁺: SrF₂ ceramic sample is used as an example.

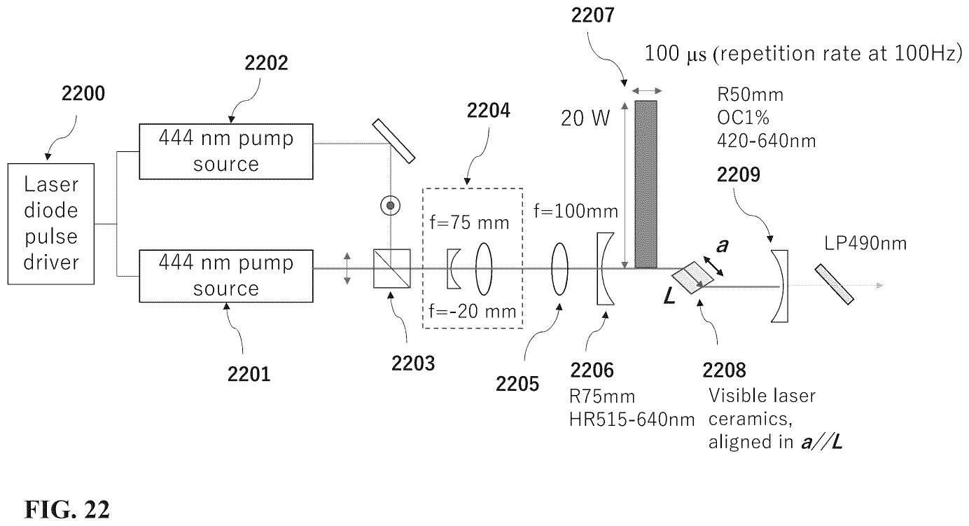

FIG. 22 indicates a schematic diagram of the visible ceramic laser. Two sets of pumping sources having a wavelength of 444 nm 2201 and 2202 are prepared. The pump sources 2201 and 2202 deliver s-polarized (here, shown perpendicular to the plane of the diagram) and p-polarized (horizontal to the diagram) laser beams, respectively. The pump sources 2201 and 2202 are each composed of an InGaN based semiconductor laser diode, collimation optics, and polarization control optics (a 2/2 waveplate), which are not separately shown in FIG. 22. The two pumping sources are operated by a laser diode pulse driver 2200, and the pump beams are combined at the polarization beam splitter 2203. In the embodiment, a pulse or quasi-continuous wave operation is applied to generate the pumping pulse 2207, whose peak power, pulse duration, and repetition rate are 20 W, 100 μs, and 100 Hz, respectively. The spatial size of the pumping beam is magnified by a telescope 2204 comprising a pair of negative and positive lenses, and the laser beam is focused by the lens 2205 into the ceramic 2208 placed in a spherical optical cavity, comprising two concave mirrors 2206 and 2209. One mirror 2206, used as a pump mirror, has a high reflectivity in the region between 515 nm to 640 nm, but transmits the pump beam at 444 nm. The other mirror 2209 has 99% reflectivity in the region from 420 nm to 640 nm, and functions as a 1% output coupler (OC). In the cavity, the most transparent axis a of the ceramic 2208 is aligned parallel to the laser path inside the cavity. The details of the arrangement of the ceramic are described below.

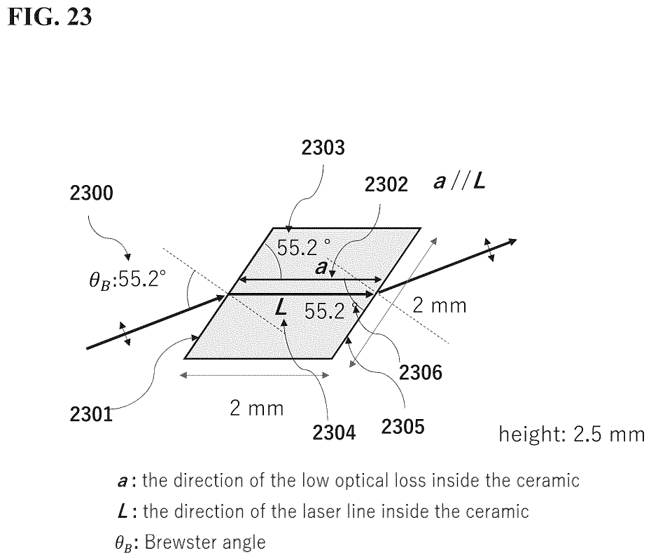

FIG. 23 illustrates the shape and arrangement of the exemplified visible laser ceramic used in FIG. 22. The surface of the ceramic 2301 was prepared such that the path for laser oscillation in the ceramic L 2304 is aligned parallel to the low optical loss axis a 2302 of the ceramic, for the incident beam at the Brewster angle, as explained in FIG. 5 for an embodiment of the optical arrangement. The ceramic was cut and optically finished such that the angle between the low optical loss axis a 2302, i.e. the more transmissive axis 7211 in FIG. 7B, and the front surface 2301 becomes the Brewster angle 55.2 degrees 2303. The end surface 2305 was prepared to be parallel to the front surface 2301 so that the axis a 2302 and the outgoing laser beam make the Brewster angle 55.2 degrees 2306 as well. The angle of 55.2 degrees for 2303 and 2306 was predetermined based on a calculation using the refractive index of the SrF₂ crystal (1.44 at 522 nm). In the design of the embodiment, the reflection loss at both surfaces for laser oscillation in p polarization can be minimized based on the Brewster angle configuration. At the same time, the scattering loss inside the ceramic is minimized as the low optical loss axis α is used for the laser oscillation. Also, by aligning the low optical loss axis a along the intended laser oscillation path, unfavorable parasitic lasing can be suppressed since the scattering losses along directions other than the α axis are higher due to the anisotropic property in transmissivity of ceramics fabricated via the disclosed uniaxial pressure-assisted processing. The uniaxial property in transmissivity is exemplified in FIG. 13B for a sample of visible laser ceramic with the composition of 0.5% Pr³⁺,5% Y³⁺: SrF₂.

Other parameters are summarized in FIG. 24A for the ceramic sample used in this exemplified embodiment. The length along the low optical loss axis, i.e. the α axis 2302 in FIG. 23, is measured as 2 mm. The Pr³⁺-activated absorption coefficient for the 444 nm pump is 1.514 cm⁻¹. Here the contribution of scattering loss to the absorption coefficient is subtracted. The optical loss along the α axis (the highly transparent direction in the ceramic sample) is 0.150 cm⁻¹.

FIG. 24B is a photograph of the ceramic sample that was cut and polished according to the design in FIG. 23 for the Brewster angle laser configuration. A visible laser operating at room temperature is realized by employing a chemically fabricated 0.5% Pr³⁺,5% Y³⁺: SrF₂ ceramic as a laser medium, which can be cost-effective for mass production, and by using gallium nitride-based diode lasers for pumping.

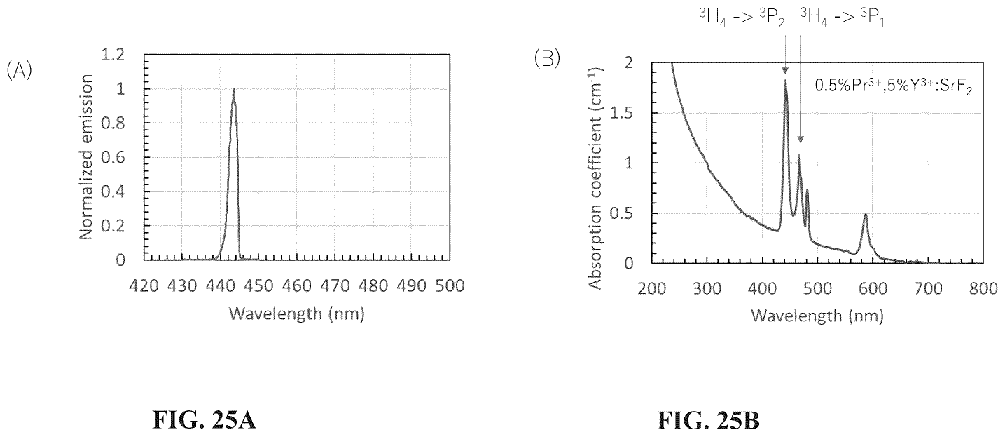

FIG. 25A shows the spectrum of the pump source. The wavelength of 444 nm was selected for the pump sources to efficiently excite the absorption band of Pr³⁺ in 0.5% Pr³⁺,5% Y³⁺: SrF₂ ceramic from the ³H₄ to the ³P₂ level as shown in FIG. 3. FIG. 25B illustrates the absorption spectrum of a 0.5% Pr³⁺,5% Y³⁺: SrF₂ ceramic, wherein the reflection loss is subtracted based on the calculated Fresnel reflection coefficient while the internal scattering loss is included, which is similar to the spectrum in FIG. 13A.

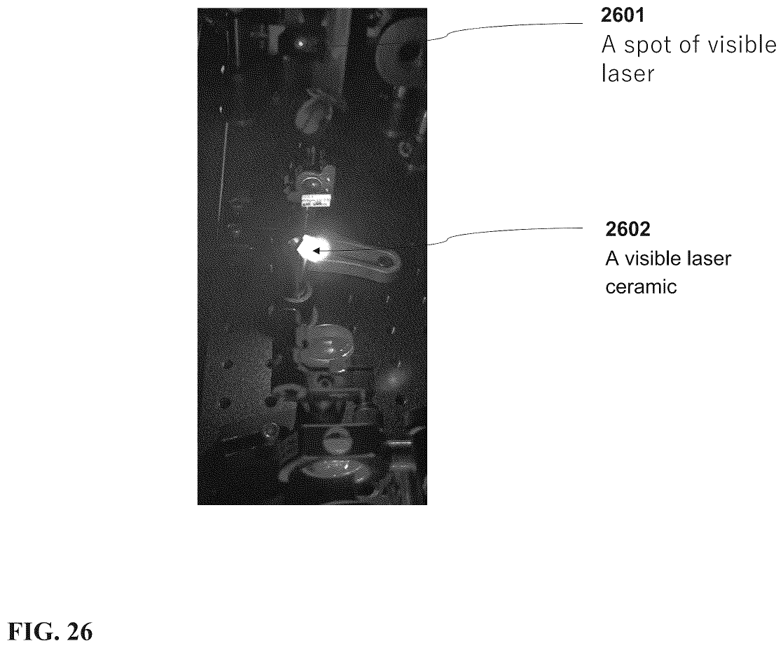

FIG. 26 is a photograph of the visible laser oscillation at room temperature enabled according to the disclosed method. Owing to the uniaxial transmissivity, no parasitic lasing was observed.

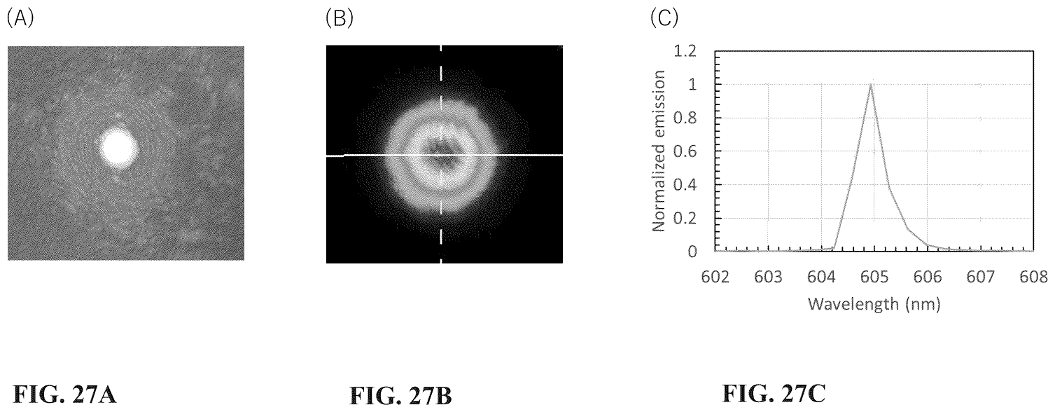

FIG. 27A is a photograph of the laser spot (orange in color), and FIG. 27B is a laser beam profile taken by a CCD camera. Both shapes are Gaussian-like circles, indicating good quality of the spatial mode. The good mode quality can be attributed to the isotropic crystal structure of the polycrystalline ceramic, which is composed of randomly-oriented ceramic grains that possess a cubic crystal structure. Also, it is revealed that the uniaxial transmissivity or the uniaxial optical scattering property does not affect the mode quality.

FIG. 27C shows the spectrum of the orange laser. The lasing wavelength is about 605 nm in an orange color with the full width at half maximum of about 0.59 nm. As we observed laser oscillation around 605 nm, visible laser oscillation at a longer wavelength can also be expected considering that scattering loss in the ceramic is mitigated at a longer wavelength and that the emission spectrum of Pr³⁺ shows prominent peaks around 640 nm and 720 nm as shown in FIG. 17.

FIG. 28A indicates a slope efficiency (0.56%) of the laser in a pulse operation (or quasi-CW operation), calculated from the irradiated pump peak power and the laser peak power, and FIG. 28B indicates a slope efficiency (1.6%) of the laser calculated from absorbed pump power and the laser output power. In the pulse operation the peak power of the pulse (with the pulse duration of 100 μs and the repetition rate of 100 Hz) was measured for both pump and laser output. The highest output in the laser operation at 605 nm was 0.05 W.

As the visible laser ceramic used in this example exhibits a typical lasing behavior, a higher slope efficiency can be achieved and the lasing thresholds (11 W in FIG. 28A and 4 W in FIG. 28B) can be lowered through further improvement in the transmissivity in the active ceramics disclosed in the embodiments.

Although the detailed description contains many specifications, these should not be construed as limiting the scope of the embodiments but as merely providing illustrations of some of several embodiments.

The scope of the invention should be determined by the appended claims and their legal equivalents, rather than by the examples given above.

### Bibliographic End Notes

[1] A. Richter et al., “Power scaling of semiconductor laser pumped Praseodymium-lasers”, Optics Express, 15, 5172-5178 (2007).
[2] T. Gün et al., “Power scaling of laser diode pumped Pr³⁺: LiYF₄ cw lasers: efficient laser operation at 522.6 nm, 545.9 nm, 607.2 nm, and 639.5 nm”, Optics Letters, 36, 1002-1004 (2011).
[3] S. Luo et al., “Power scaling of blue-diode-pumped Pr: YLF lasers at 523.0, 604.1, 606.9, 639.4, 697.8 and 720.9 nm” Optics Communications, 380, 357-360 (2016).
[4] F. Cornacchia et al., “Efficient visible laser emission of GaN laser diode pumped Pr-doped fluoride scheelite crystals”, Optics Express, 16, 15932-15941 (2008).
[5] E. Reichert et al., “Diode pumped laser operation and spectroscopy of Pr³⁺: LaF₃”, Optics Express, 20, 20387-20395 (2012).
[6] T. T. Basiev et al., “First ceramic laser in the visible spectral range”, Optics Express, 1, 1511-1514 (2011).
[7] M. Fibrich et al., “InGaN diode pumped Pr: SrF₂ laser at 639 nm wavelength”, Proceedings of SPIE, Solid State Lasers XXVI: Technology and Devices, 100822, 1008220-1-1008220-5 (2017).
[8] C. Xu et al., “Continuous-wave orange laser at 605.98 nm based on a diode-pumped Pr, Gd: SrF₂ crystal”, Optics & Laser Technology, 168, 109768-1-109768-7 (2024).
[9] H. Yu et al., “Enhanced photoluminescence and initial red laser operation in Pr: CaF₂ crystal via co-doping Gd³⁺ ions”, Materials Letters, 206, 140-142 (2017).
[10] H. Okamoto et al., “Visible-NIR tunable Pr³⁺-doped fiber laser pumped by a GaN laser diode”, Optics Express, 17, 20227-20232 (2009).
[11] N. Sugiyama et al., “Diode-pumped 640 nm Pr: YLF regenerative laser pulse amplifier”, Optics Letters, 44, 3370-3373 (2019).
[12] Y. Hara et al., “640-nm Pr: YLF regenerative amplifier seeded by gain-switched laser diode pulses”, Applied Optics, 59, 5098-5101 (2020).
[13] H. Yada et al., “SYSTEM AND METHOD FOR AMPLIFICATION OF GREEN LASER PULSES”, patent application (2020).
[14] H. Yada et al., “Ultrashort green laser pulse amplification in praseodymium doped LiYF₄ crystal pumped by InGaN based laser diodes”, CLEO (post deadline session), SFIB.2 (2021).
[15] F. Okada et al., “Solid-state ultraviolet tunable laser: A Ce³⁺ doped LiYF₄ crystal”, Journal of Applied Physics, 75, 49-53 (1994).
[16] A. Ikesue et al., “Ceramic laser materials”, Nature Photonics, 2, 721-727 (2008).
[17] F. Druon et al., “On Yb: CaF₂ and Yb: SrF₂: review of spectroscopic and thermal properties and their impact on femtosecond and high power laser performance”, Optical Materials Express, 1, 489-502 (2011).
[18] B. Woods et al., “Thermomechanical and thermo-optical properties of the LiCaAlF₆: Cr³⁺ laser material”, Journal of the Optical Society of America B, 8, 970-977 (1991).
[19] D. T. Morelli et al., “Thermal conductivity of single-crystal barium fluoride”, Journal of Applied Physics, 63, 573-574 (1988).
[20] X. Zhu et al., “High-power ZBLAN glass fiber lasers: review and prospect”, Advances in OptoElectronics, 2010, 1-23 (2010).
[21] “Optical amplifier and laser incorporating such an amplifier” U.S. Pat. No. 8,995,488B2 (2011).
[22] C. B. Carter et al., “Ceramic Materials: Science and Engineering, 2^{nd} edition”, Springer (2013).
[23] S. Saber-Samandari et al., “Micromechanical properties of single crystal hydroxyapatite by nanoindentation”, Acta Biomaterialia, 5, 2206-2212 (2009).
[24] A. A. Kaminskii et al., “Microhardness and fracture toughness of Y₂O₃—and Y₃Al₅O₁₂-based nanocrystalline laser ceramics”, Crystallography Reports, 50, 869-873 (2005).
[25] S. Qin et al., “Study in optical and mechanical properties of Nd³⁺, Y³⁺: SrF₂ transparent ceramics prepared by hot-pressing and hot-forming techniques”, Crystals, 9, 619-1-619-10 (2019).
[26] S. Fujita et al., “Output characteristics of Pr: YAlO₃ and Pr: YAG lasers pumped by high-power GaN laser diodes”, Applied Optics, 59, 5124-5130 (2020).
[27] G. Yi et al., “Preparation and characterizations of Pr³⁺: CaF₂ transparent ceramics with different doping concentrations”, Ceramics International, 45, 3541-3546 (2019).
[28] G. Yi et al., “Microstructural and optical properties of Pr³⁺: (Ca_{0.97}Gd_{0.03}) F_{2.03} transparent ceramics sintered by vacuum hot-pressing method”, Journal of Luminescence, 214, 116575-1-116575-6 (2019).
[29] G. Yi et al., “Gd³⁺ doping induced microstructural evolution and enhanced visible luminescence of Pr³⁺ activated calcium fluoride transparent ceramics”, Ceramics International, 49, 7333-7340 (2023).
[30] G. Yi et al., “Synthesis and luminescence characterization of Pr³⁺, Gd³⁺ co-doped SrF₂ transparent ceramics”, Journal of the American Ceramic Society, 103, 279-286 (2020).
[31] Z. Liu et al., “Fabrication and optical characterizations of PrF₃-doped SrF₂ transparent ceramics”, Optical Materials, 122, 111710-1-111710-9 (2021).
[32] Z. Liu et al., “Enhanced visible luminescence intensities in hot-pressed Pr, La: SrF₂ transparent ceramics by co-doping with LaF₃”, Journal of Luminescence, 256, 119652-1-119652-9 (2023).
[33] X. Liu et al., “The effects of the solution reactant concentration and temperature on the preparation of Pr³⁺: BaF₂ transparent ceramics”, Journal of the American Ceramic Society, 104, 3862-3872 (2021).
[34] X. Liu et al., “Effect of Pr³⁺ doping concentration on microstructure and optical properties of transparent BaF₂ ceramics”, Journal of Alloys and Compounds, 895, 162623-1-162623-11 (2022).
[35] “Solid state laser device with reduced temperature dependence” U.S. Pat. No. 8,000,363B2 (2008).
[36]“ [symbol] - [symbol] - [symbol] [symbol] ” (” Visible laser materials and their manufacturing method”) JPA 2021134358 (2021).
[37]“- [symbol] [symbol] [symbol] [symbol] “(” A praseodymium doped strontium fluoride laser ceramic for red-orange laser output and preparation method thereof”) CN106673658A (2017).
[38] S. Kitajima et al., “Yb³⁺-doped CaF₂—LaF₃ ceramics laser”, Optics Letters, 42, 1724-1727 (2017).
[39] S. A. Payne et al., “Spectroscopy and gain measurements of Nd³⁺ in SrF₂ and other fluorite-structure hosts”, Journal of the Optical Society of America B, 8, 726-740 (1991).
[40] S. V. Kuznetsov et al., “Inorganic nanofluorides and related nanocomposites”, Russian Chemical Reviews, 75, 1065-1082 (2006).
[41] B. P. Sobolev et al., “Fluorite M₁₋ₓRₓF₂₊ x phases (M=Ca, Sr, Ba; R=rare earth elements) as nanostructured materials”, Crystallography Reports, 48, 141-161 (2003).
[42] M. E. Doroshenko et al., “Progress in fluoride laser ceramics”, Physica Status Solidi C, 10, 952-957 (2013).
[43] A. Lyberis et al., “Origin of light scattering in ytterbium doped calcium fluoride transparent ceramic for high power lasers”, Journal of the European Ceramic Society, 31, 1619-1630 (2011).

What is claimed:

1. A gain medium for a laser or laser amplifier comprising;
a ceramic gain material capable of lasing in the human visible range, comprising:
a composition comprising an alkaline-earth metal fluoride AF₂, where AF₂=CaF₂, SrF₂, BaF₂, or their solid solution, and serving as a host media;
said host media being doped with trivalent praseodymium (Pr³⁺) and co-doped with one or more other trivalent rare earth (RE) elements selected from the group consisting of Lu³⁺, Y³⁺, Gd³⁺, and La³⁺;
said composition further characterized by xat, % Pr³⁺, yat, % RE³⁺: AF₂, wherein x and y fall within the ranges of 0.2<x<1 and 2<y<10, respectively.

2. A visible laser or laser amplifier, comprising;
a source of pump light;
a gain medium arranged so as to be excited by said pump light and to generate laser emissions thereby, wherein
the gain medium is a ceramic having an anisotropic scattering property, such that a scattering loss for a visible laser beam passing along one axis of said gain medium is lower than that along other axes perpendicular to said one axis, and wherein
an optical path for laser oscillation or laser amplification in said ceramic is configured to be along said one axis, or parallel to or nearly parallel to said one axis.

3. The visible laser or laser amplifier of claim 2,
wherein the said anisotropic scattering property is uniaxial, and the scattering loss for a visible laser beam along said uniaxial direction is lower than that along any other axis perpendicular to the uniaxial direction.

4. The visible laser of claim 2,
wherein said ceramic gain medium includes a trivalent praseodymium dopant,
and wherein said pump laser comprises a gallium nitride-based diode laser for pumping said gain medium, to excite said dopant,
thereby to produce a visible laser output from said gain medium.

5. The visible laser amplifier of claim 2,
wherein said ceramic gain medium comprises a trivalent praseodymium dopant,
and wherein said pump laser comprises a gallium nitride-based diode laser for pumping said gain medium to excite said dopant,
a seed laser source, coupled to said cavity and completing one or multiple passes through the gain medium, wherein, of multiple passes, each pass is through a slightly different volume of the gain medium, and
wherein a beam of said pump laser fully illuminates each of the passed volumes of the gain medium to excite said dopant and effect amplification of said seed pulse thereby.

6. The laser or laser amplifier of claim 2,
wherein the host material of said ceramic gain material is based on CaF₂ SrF₂, BaF₂ or a solid solution thereof.

7. The laser or laser amplifier of claim 2,
wherein said ceramic gain material has a composition of alkaline-earth metal fluoride AF₂ (AF₂=CaF₂, SrF₂, BaF₂, or their solid solution) co-doped with trivalent praseodymium (Pr³⁺) and one or more other trivalent rare earth (RE) elements chosen from the group of Lu³⁺, Y³⁺, Gd³⁺, and La³⁺.

8. The laser or laser amplifier of claim 7 wherein a composition of said co-dopants within said host being defined by x % Pr³⁺,y % RE³⁺: AF₂), wherein x and y fall within the ranges of 0.2<x<1 and 2<y<10, respectively.

9. The laser or laser amplifier of claim 2
wherein a wavelength of the laser output or the amplified laser output is in the range between 479 nm to 725 nm.

10. The laser or laser amplifier of claim 2 wherein said ceramic gain medium comprises a uniaxially compressed and sintered body.

11. The laser or laser amplifier of claim 2, wherein said gain medium is a uniaxially compressed and sintered body of SrF₂ doped with at least Pr³⁺.

12. The laser or laser amplifier of claim 2, wherein said gain medium includes at least one other trivalent RE element as a co-dopant, selected from among Lu³⁺, Y³⁺, Gd³⁺, and La³⁺.

13. The laser or laser amplifier of claim 11, wherein said gain medium includes at least one other trivalent RE element as a co-dopant, selected from among Lu³⁺, Y³⁺, Gd³⁺, and La³⁺.

14. A process of manufacturing a gain medium of a ceramic visible laser, comprising;
providing a first ceramic material comprising an alkaline-earth metal fluoride and at least one RE metal dopant having face-centered cubic crystal structure, in powder form,
compressing and sintering said first material powder in a die, by applying at least one pressure-assisted process, uniaxially, in a main axis direction, and by applying at least one sintering process thereto and
removing the compressed and sintered first material from said die and performing cutting and polishing thereon to form a desired shape.

15. The process as claimed in claim 14, further including the precursor steps of:
precipitating solids from an aqueous mixture of one or more alkaline earth metal compounds and one or more trivalent RE compounds by wet-chemistry precipitation using a fluorine-containing compound;
washing and drying said precipitated solids to prepare said powder.

16. The process as claimed in claim 14, wherein said pressure-assisted process comprises at least one of dry pressing, hot pressing, and spark plasma sintering, and said sintering process comprises at least one of hot pressing, spark plasma sintering, vacuum sintering, sintering in air, sintering in an inert atmosphere, and hot isostatic pressing.

17. The process as claimed in claim 16, wherein said pressure-assisted process and said sintering process can be performed simultaneously using one technique, such as hot pressing, and spark plasma sintering.

18. A process of constructing a laser or laser amplifier, comprising:
preparing a ceramic gain medium according to the process of claim 14, and further comprising the steps of:
placing said ceramic gain medium in a laser cavity such that said uniaxial direction is paralleled with an optical axis of said cavity, and
providing a diode laser pump, such that an output beam of said pump encompasses a substantial volume of said gain medium.
